(19) United States
(12) Patent Application Publication
(10) Pub. No.: US 2023/0265233 A1
(43) Pub. Date: Aug. 24, 2023

(54) POLYURETHANE FOAMS WITH IMPROVED ACOUSTIC PROPERTIES

(71) Applicant: BASF SE, Ludwigshafen am Rhein (DE)

(72) Inventors: Iran OTERO MARTINEZ, Lemfoerde (DE); Alexander RAETH, Lemfoerde (DE); Sonja ALTMEPPEN, Lemfoerde (DE); Bianca FRISCHE, Lemfoerde (DE)

(21) Appl. No.: 18/013,273

(22) PCT Filed: Jun. 30, 2021
(86) PCT No.: PCT/EP2021/067993

§ 371 Date: Dec. 28, 2022

(30) Foreign Application Priority Data
Jul. 1, 2020 (EP) 20183359.7

(51) Int. Cl. C08G 18/08; C08G 18/12; C08G 18/48; C08G 18/63; C08J 9/12; C08J 9/00

(52) U.S. Cl. CPC C08G 18/14; C08G 18/12; C08G 18/4816; C08G 18/4829; C08G 18/4837; C08G 18/632; C08J 9/125; C08J 9/0061; C08G 2101/00

(57) ABSTRACT

The invention relates in a first aspect to a process for producing a polyurethane foam, comprising the reaction of (a) an isocyanate composition comprising at least one polyisocyanate based on diphenylmethane diisocyanate; (b) a polyol mixture, wherein the polyol mixture comprises (b1) 50% to 85% by weight of at least one polyether polyol having a hydroxyl value in the range from 10 to 60 mg KOH/g, an OH functionality of more than 2, and an ethylene oxide proportion in the range from 50% to 100% by weight based on the alkylene oxide content of the at least one polyether polyol, and (b2) 15% to 50% by weight of at least one polyether polyol having a hydroxyl value in the range from 10 to 100 mg KOH/g, an OH functionality of more than 2, an ethylene oxide proportion in the range from 2% to 30% by weight based on the alkylene oxide content of the at least one polyether polyol, and a proportion of primary OH groups of 40 to 100% based on the total number of OH groups in the at least one polyether polyol, in each case based on the total amount by weight of constituents (b1) and (b2), which adds up to 100% by weight, and (b3) 0 to 20 further parts by weight of an optionally derivatized filler, based on 100 parts by weight of components (b1) and (b2), optionally present as a constituent of a graft polyol based on one or more of components (b1) and (b2); (c) a blowing agent composition comprising water; wherein the reaction employs the blowing agent composition (c) in a weight-based ratio of the weight of blowing agent composition (c) to the total weight of all isocyanate-reactive compounds used in the reaction in the range from 1:14 to 1:6; wherein a polyurethane foam having a foam density, determined according to DIN EN ISO 845 (October 2009), of not more than 25 kg/m³ and a compression hardness, determined at 40% compression in the first compression in accordance with DIN EN ISO 3386-1 (October 2015), in the range from 10 to 80 kPa is obtained.

In a second aspect, the invention relates to a polyurethane foam obtained or obtainable by the process of the first aspect.

A third aspect of the invention relates to the use of a polyurethane foam according to the second aspect as a sound absorption material.

According to a fourth aspect, the invention relates to a sound absorption material comprising a polyurethane foam according to the second aspect, preferably consisting of a polyurethane foam according to the second aspect.

A fifth aspect of the invention relates to the use of a polyol mixture (b) comprising (b1), (b2), and (b3) as defined in the first aspect, for producing a polyurethane foam.

The invention relates in a first aspect to a process for producing a polyurethane foam, comprising the reaction of (a) an isocyanate composition comprising at least one polyisocyanate based on diphenylmethane diisocyanate; (b) a polyol mixture, wherein the polyol mixture comprises (b1) 50% to 85% by weight of at least one polyether polyol having a hydroxyl value in the range from 10 to 60 mg KOH/g, an OH functionality of more than 2, and an ethylene oxide proportion in the range from 50% to 100% by weight based on the alkylene oxide content of the at least one polyether polyol, and (b2) 15% to 50% by weight of at least one polyether polyol having a hydroxyl value in the range from 10 to 100 mg KOH/g, an OH functionality of more than 2, an ethylene oxide proportion in the range from 2% to 30% by weight based on the alkylene oxide content of the at least one polyether polyol, and a proportion of primary OH groups of 40 to 100% based on the total number of OH groups in the at least one polyether polyol, in each case based on the total amount by weight of constituents (b1) and (b2), which adds up to 100% by weight, and (b3) 0 to 20 further parts by weight of an optionally derivatized filler, based on 100 parts by weight of components (b1) and (b2), optionally present as a constituent of a graft polyol based on one or more of components (b1) and (b2); (c) a blowing agent composition comprising water; wherein the reaction employs the blowing agent composition (c) in a weight-based ratio of the weight of blowing agent composition (c) to the total weight of all isocyanate-reactive compounds used in the reaction in the range from 1:14 to 1:6; wherein a polyurethane foam having a foam density, determined according to DIN EN ISO 845 (October 2009), of not more than 25 kg/m³ and a compression hardness, determined at 40% compression in the first compression in accordance with DIN EN ISO 3386-1 (October 2015), in the range from 10 to 80 kPa is obtained.

In a second aspect, the invention relates to a polyurethane foam obtained or obtainable by the process of the first aspect. A third aspect of the invention relates to the use of a polyurethane foam according to the second aspect as a sound absorption material. According to a fourth aspect, the invention relates to a sound absorption material comprising a polyurethane foam according to the second aspect, preferably consisting of a polyurethane foam according to the second aspect. A fifth aspect of the invention relates to the use of a polyol mixture (b) comprising (b1), (b2), and (b3) as defined in the first aspect, for producing a polyurethane foam.

Polyurethane foams are used in means of transport for a diversity of purposes. For example, flexible polyurethane foams are often used as a material for car seats and car carpets as a consequence of their mechanical characteristics in respect of hardness, elasticity, elongation, and tensile strength, with interactions existing for example in resilience and density. Another important parameter for flexible polyurethane foams is their density. An aim here is to reduce the density for cost and weight reasons in order to use as little material as possible. However, reducing the density while leaving the hardness unchanged results in a reduction in elasticity. Another important parameter for the comfort properties of flexible polyurethane foams in furniture for sitting and lying down is high air permeability.

WO 2019/002013 A1 describes flexible polyurethane foams having improved air permeability that are based on a special polyol mixture. The flexible polyurethane foams are used as mattresses or cushions, as upholstery elements for furniture or as seating elements.

A car carpet is disclosed in EP 1 664 147 B1, the car carpet being a thermoformed flexible polyurethane-based foam obtainable by reacting polyisocyanates with polymer polyols to form a flexible polyurethane foam and subsequent irreversible thermoforming of the resulting flexible foam at temperatures above the glass transition temperature of the thermoplastic polymers. WO 2009/003964 A1 relates to a resin composition and to a polyurethane system for use in shaping a polyurethane article, the polyurethane article being used in particular for seats.

For sound absorption applications, particularly in a means of transport, a polyurethane foam must meet certain requirements in respect of its properties, for example its density (foam density) and hardness must have appropriate values; the foam density should be <25 kg/m³ and the hardness in the range from 10 to 80 kPa.

EP 1 230 297 B1 relates to a process for producing rigid polyurethane foams and flexible polyurethane foams that comprise a flame retardant. Applications mentioned include inter alia sound insulation in automotive applications and vibration insulation in general. EP 2 800 770 B2 describes a process for producing a flame-retardant semi-rigid polyurethane foam or a rigid polyurethane foam having a density of 5 to 50 g/L (kg/m³) and a compressive stress at 10% compression according to DIN 53 421/DIN EN ISO 604 from greater than 15 to less than 80 kPa. The semi-rigid polyurethane foam or rigid polyurethane foam is used in means of transport for soundproofing walls, doors, and roofs or in the engine compartment.

For sound absorption applications, particularly in a means of transport, the acoustic properties of a polyurethane foam must also be suitable for sound absorption, i.e. the air permeability should have good values, while the air flow resistance should at the same time show sufficiently good values. For the production of the corresponding parts, it is also relevant that a corresponding foam is thermoformable.

An object of the invention was therefore to provide a polyurethane foam and a process for the production thereof, wherein the polyurethane foams should have appropriate densities (foam densities) of less than 25 kg/m³ accompanied by compression hardnesses of at least 10 kPa. The polyurethane foams should also have suitable acoustic properties, in particular air permeability accompanied by appropriate values for air flow resistance. In addition, the polyurethane foams should be thermoformable.

The object is according to a first aspect achieved by a process for producing a polyurethane foam, comprising the reaction of:

(a) an isocyanate composition comprising at least one polyisocyanate based on diphenylmethane diisocyanate;

(b) a polyol mixture comprising
b1) 50% to 85% by weight of at least one polyether polyol having a hydroxyl value in the range from 10 to 60 mg KOH/g, an OH functionality of more than 2, and an ethylene oxide proportion in the range from 50% to 100% by weight based on the alkylene oxide content of the at least one polyether polyol,
(b2) 15% to 50% by weight of at least one polyether polyol having a hydroxyl value in the range from 10 to 100 mg KOH/g, an OH functionality of more than 2, an ethylene oxide proportion in the range from 2% to 30% by weight based on the alkylene oxide content of the at least one polyether polyol, and a proportion of primary OH groups of 40 to 100% based on the total number of OH groups in the at least one polyether polyol,
   in each case based on the total amount by weight of constituents (b1) and (b2), which adds up to 100% by weight,
   and
(b3) 0 to 20 further parts by weight of an optionally derivatized filler, based on 100 parts by weight of components (b1) and (b2), optionally present as a constituent of a graft polyol based on one or more of components (b1) and (b2);

(c) a blowing agent composition comprising water;

wherein the reaction employs the blowing agent composition (c) in a weight-based ratio of the weight of blowing agent composition (c) to the total weight of all isocyanate-reactive compounds used in the reaction in the range from 1:14 to 1:6;

wherein a polyurethane foam having a foam density, determined according to DIN EN ISO 845 (October 2009), of not more than 25 kg/m³ and a compression hardness, determined at 40% compression in the first compression in accordance with DIN EN ISO 3386-1 (October 2015), in the range from 10 to 80 kPa is obtained.

Isocyanate-reactive compounds are compounds having one or more isocyanate-reactive functionalities, preferably selected from the group consisting of thio group, hydroxyl group, amino group (—NH— or —NH₂), carboxylic acid group, and carboxamide group, more preferably from the group consisting of thio group, hydroxyl group, and amino group (—NH— or NH₂), more preferably the one or more isocyanate-reactive functionalities are hydroxyl groups. Isocyanate-reactive compounds are more particularly the polyols in polyol mixture (b), i.e. (b1), (b2), optionally (b4), optionally also chain extenders and crosslinkers, and also some catalysts, for example amine-containing catalysts, as explained in more detail further below.

The hydroxyl value is in the context of the present invention understood as meaning the hydroxyl value determined in accordance with DIN 53240. It is expressed in mg KOH/g. The hydroxyl value is related to the molecular weight Mn via the formula Mn [g/mol]=(f*56 106 g/mol)/OHV [mg/g], where f is the OH functionality of the polyether polyol.

The OH functionality of a compound is in the context of the present invention is understood as meaning the number of reactive OH groups per molecule.

In the case of the polyether polyols in polyol mixture b), the OH functionality refers to the number of reactive OH groups per molecule. If mixtures of compounds having different functionality are used for a particular component, the functionality of the components in each case results from the number-weighted average of the functionality of the individual compounds, i.e. functionality is always to be understood as meaning the number-average functionality. A “polyether polyol having an OH functionality of 2.2” is additionally understood as meaning a polyether polyol having an average number of hydroxyl groups per molecule in the range from 2.0 to 2.2. In practice, there will be a deviation from the nominal functionality, since various side reactions during the polyol synthesis can result in a functionality that may in reality be lower than what was nominally assumed (M. Ionescu, Chemistry and Technology of Polyols, Rapra, 2005, pp. 67-75).

The polyurethane foam (PU foam) obtained from the process according to the invention has the characteristic features, besides its foam density and compression hardness, of an air flow resistance (AFR) determined in accordance with DIN EN ISO 9053-1 (March 2019) of not more than 10 000 Pa·s/m and also an air permeability determined in accordance with DIN EN ISO 7231 (December 2010) of at least 0.02 dm³/s. Further details on the PU foam are described hereinbelow in respect of the second aspect of the invention.

### Polyol Mixture (b)

The process according to the invention employs a polyol mixture (b). Preferably, the polyol mixture (b) comprises the at least one polyether polyol (b1) in the range from 60% to 82% by weight, preferably in the range from 65% to 80% by weight, more preferably in the range from 68% to 78% by weight, more preferably in the range from 70% to 75% by weight, based on the total amount by weight of constituents (b1) and (b2), which adds up to 100% by weight.

Preferably, the polyol mixture (b) comprises the at least one polyether polyol (b2) in the range from 18% to 40% by weight, preferably in the range from 21% to 32% by weight, even more preferably 25% to 30% by weight, based on the total amount by weight of constituents (b1) and (b2), which adds up to 100% by weight.

### Polyether Polyol (b1)

The polyol mixture (b) comprises a polyether polyol (b1). Preferably, the polyether polyol (b1) has an OH functionality in the range from 2.2 to 8, preferably in the range from 2.2 to 4, more preferably in the range from 2.4 to 3.3.

The hydroxyl value of the polyether polyols (b1) is preferably in the range from 15 to 58 mg KOH/g, more preferably in the range from 20 to 55 mg KOH/g, more preferably in the range from 25 to 50 mg KOH/g.

Polyether polyols (b1) of this kind may be referred to as cell-opening polyols, since their inclusion generally gives the flexible polyurethane foam an increased open-cell content. The cell-opening polyols included according to the invention are known from the prior art. The amounts of cell-opening polyol used in the prior art in the production of elastic foams are generally less than 20% by weight of the polyol component. In the case of hypersoft foams, which are very flexible foams having a compression hardness, determined at 40% compression in accordance with DIN EN ISO 3386-1 (October 2015), of less than 2 kPa, high proportions of cell-opening polyol are used in production, usually between 70% and 80% by weight based on all polyols used. The use of cell-opening polyols of this kind in amounts ranging from 60% to 82% by weight based on the total amount by weight of constituents (b1) and (b2), which adds up to 100% by weight, is thus far unknown in the prior art for foams having a compression hardness of more than 10 kPa that are thermoformed or are thermoformable.

Preferably, the polyether polyol (b1) has a proportion of primary OH groups in the range from 40 to 100%, preferably in the range from 50 to 90%, more preferably in the range from 60 to 90%, more preferably in the range from 70 to 90%, based on the total number of OH groups in the polyether polyol (b1). The proportions of primary and secondary OH groups are preferably determined from the ¹H NMR spectra of the peracetylated polyether polyols in accordance with ASTM D-4273-11.

The preparation of polyether polyols (b1) is known from the prior art. Suitable polyether polyols (b1) and the preparation thereof are described in more detail for example in DE 4318120 A1.

Starter compounds used for preparing the polyether polyols (b1) are preferably hydroxy-functional or amino-functional. Examples of suitable starter compounds are propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, dodecane-1,12-diol, glycerol, trimethylolpropane, triethanolamine, pentaerythritol, sorbitol, sucrose, hydroquinone, pyrocatechol, resorcinol, bisphenol F, bisphenol A, 1,3,5-trihydroxybenzene, and methylol-containing condensates of formaldehyde and phenol or melamine or urea. The starter compound used is preferably glycerol, trimethylolpropane, sucrose, and/or sorbitol. The polyether polyols (b1) are particularly preferably prepared on the basis of trifunctional starters, in particular glycerol.

The proportion of ethylene oxide in the total amount by weight of alkylene oxide in (b1) is preferably in the range from 60% to 100% by weight, especially from 65% to 90% by weight, more preferably in the range from 70% to 85% by weight. In a first preferred embodiment, ethylene oxide is used exclusively as the alkylene oxide. In a further preferred embodiment, ethylene oxide is used in admixture with at least one further alkylene oxide. Examples of suitable further alkylene oxides are propylene oxide, 1,2-butylene oxide or 2,3-butylene oxide, and styrene oxide. The further alkylene oxide is preferably propylene oxide. Propylene oxide and ethylene oxide are preferably fed into the reaction mixture individually, in admixture, or successively. If the alkylene oxides are added successively, the products produced comprise polyether chains having block structures. Increasing the content of ethylene oxide in the ethylene oxide/propylene oxide mixture generally results in an increase in the proportion of primary OH groups in the polyether polyol. The proportion of primary OH end groups can be increased through subsequent addition of pure ethylene oxide. Products having ethylene oxide end blocks have a particularly high proportion of primary OH groups.

### Polyether Polyol (b2)

The polyol mixture (b) comprises a polyether polyol (b2). The polyether polyol (b2) preferably has an OH functionality in the range from 2.2 to 8, preferably in the range from 2.2 to 4, more preferably in the range from 2.4 to 3.3.

The hydroxyl value of the polyether polyols (b2) is preferably in the range from 15 to 90 mg KOH/g, more preferably in the range from 20 to 80 mg KOH/g, more preferably in the range from 25 to 50 mg KOH/g.

In addition, in one embodiment of the process, the polyether polyol (b2) has a proportion of primary OH groups in the range from 50 to 100%, preferably in the range from 70 to 90%, based on the total number of OH groups in the polyether polyol (b2). The proportions of primary and secondary OH groups are preferably determined from the ¹H NMR spectra of the peracetylated polyether polyols in accordance with ASTM D-4273-11.

In a further embodiment, preference is given to using in (b2) highly functional polyether polyols having an OH functionality in the range from more than 4 to not more than 8, more preferably in the range from more than 4 to 6, more preferably in the range from 4.1 to 6. In this embodiment, particular preference is given to the use as starter of sucrose, sorbitol or mixtures thereof or mixtures of the abovementioned compounds with glycerol.

The preparation of polyether polyols (b2) is known from the prior art. Suitable polyether polyols (component b2) can be prepared by known processes, for example by anionic polymerization using as catalysts alkali metal hydroxides, for example sodium hydroxide or potassium hydroxide, or alkali metal alkoxides, for example sodium methoxide, sodium ethoxide, potassium ethoxide or potassium isopropoxide. One such method of preparation is described in more detail in DE 4318120 A1.

Suitable starter compounds for preparing the polyether polyols (b2) are identical to those mentioned for the polyether polyol (b1). In a preferred embodiment, the polyether polyols (b2) are prepared on the basis of trifunctional or higher functional starters, particularly preferably trifunctional starters, very particularly preferably glycerol.

The proportion of ethylene oxide in the total amount by weight of alkylene oxide in (b2) is preferably in the range from 5% to 30% by weight, especially in the range from 5% to 25% by weight, more preferably in the range from 8% to 22% by weight. Ethylene oxide is thus used in admixture with at least one further alkylene oxide. Examples of suitable further alkylene oxides are propylene oxide, 1,2-butylene oxide or 2,3-butylene oxide, and styrene oxide. The further alkylene oxide is preferably propylene oxide. Propylene oxide and ethylene oxide are preferably fed into the reaction mixture individually, in admixture, or successively. If the alkylene oxides are added successively, the products produced comprise polyether chains having block structures. The addition of pure ethylene oxide in the last step of the alkoxylation results in products having ethylene oxide end blocks. Such products having ethylene oxide end blocks have a particularly high proportion of primary end groups.

In a preferred embodiment, the polyether polyol (b2) is used wholly or partly in derivatized form, for example in the form of a graft polyol, i.e. in combination with the optionally derivatized filler (b3), to form the mixture b. This embodiment is elucidated in more detail hereinbelow in the context of the optionally derivatized filler (b3).

### Optional Derivatized Filler (b3)

The polyol mixture (b) optionally comprises 0 to 20 further parts by weight of an optionally derivatized filler, based on 100 parts by weight of components (b1) and (b2), optionally present as a constituent of a graft polyol based on one or more of components (b1) and (b2);

A filler is in the context of the present invention understood as meaning a solid.

The optionally derivatized filler according to (b3) is present as a constituent of a graft polyol based on a polyether polyol (b2), preferably in an amount in the range from 0.01 to 20 further parts by weight, more preferably in the range from 1 to 10 further parts by weight, based on 100 parts by weight of components (b1) and (b2);

and/or

the filler according to (b3) is present as a dispersion in a polyether polyol (b2), preferably in an amount in the range from 0.01 to 20 further parts by weight, more preferably in the range from 1 to 10 further parts by weight, more preferably in the range from 3 to 8 further parts by weight, based on 100 parts by weight of components (b1) and (b2).

The optionally derivatized filler according to (b3) preferably comprises a polymer, the optionally derivatized filler preferably consisting of the polymer to an extent in the range from 95% to 100% by weight, more preferably to an extent in the range from 98% to 100% by weight, more preferably to an extent in the range from 99% to 100% by weight, more preferably to an extent of 100% by weight, the polymer preferably being selected from the group consisting of (co)polymers based on styrene-acrylonitrile and/or acrylonitrile, more preferably at least poly(styrene-acrylonitrile) (SAN).

In one embodiment of the process, the polyol mixture (b) contains no fillers (b3).

In a further embodiment, the polyol mixture (b) comprises the filler (b3) in derivatized form as a constituent of a graft polyol, i.e. in combination with polyether polyols. The use of graft polyols results in improved tensile strength. The use of graft polyols also results in the polyol mixture (b) having better compatibility and long-term stability. It is advantageous here to use polyether polyols (b2) as base polymer for the graft polyols. Graft polyols of this kind are known from the prior art or can be prepared by known methods.

SAN particles are particularly preferred as filler. In a preferred embodiment of the process, the derivatized filler is used as a graft polyol in the form of a polymer-modified polyether polyol, preferably graft polyether polyol, which is produced by in-situ polymerization of acrylonitrile, styrene or preferably mixtures of styrene and acrylonitrile, preferably in a weight ratio of from 90:10 to 10:90, more preferably 70:30 to 30:70, in a polyether polyol (b2). Instead of the polyether polyol (b2), it is also possible to employ a polyether polyol dispersion that comprises as the disperse phase, usually in an amount of from 1% to 50% by weight, preferably 2% to 25% by weight: for example polyureas, polyhydrazides, polyurethanes containing tert-amino groups in bonded form, and/or melamine. Production processes for such polyether polyol dispersions are known and are described in more detail for example in “Dow Polyurethanes Flexible Foams”, 2nd edition 1997, chapter 2.

In a further embodiment, the filler according to (b3) is present as a dispersion in a polyether polyol (b2). For example, a dispersion of a filler (b3) can be obtained in what is known as the melt emulsification process. This process is described in WO 2009/138379 A1. In the process, a thermoplastic polymer, optionally together with a stabilizer, and polyamine are heated to a temperature above the melting point of the thermoplastic polymer, homogenized, for example using ultrasound, an extruder or a toothed-ring dispersing machine, and cooled to a temperature below the melting point of the thermoplastic polymer. All thermoplastic polymers may in principle be used for this. Preference is given to using thermoplastic polymers that can be obtained by polymerization of the abovementioned monomers. Optionally, an emulsifier is further added. For example, the stabilizers and emulsifiers described in WO 2009/138379 may be used. In a preferred embodiment, the thermoplastic polymer to be used in the melt emulsification process is poly(styrene-acrylonitrile).

### Further Polyether Polyol (b4)

In one embodiment of the process, the polyol mixture (b) further comprises:

(b4) at least one further polyether polyol that differs from the at least one polyether polyol according to (b1) and from the at least one polyether polyol according to (b2) and has a hydroxyl value of more than 350 mg KOH/g, preferably in the range from 350 to 800 mg KOH/g.

The further polyether polyol (b4) preferably has an OH functionality of 3 or more, more preferably in the range from 3 to 5, more preferably in the range from 3 to 4.

Polyether polyols (b4) are referred to also as rigid foam polyols. The preparation of polyether polyols (b4) is known from the prior art. For example, they can be prepared by anionic polymerization using alkali metal hydroxides such as sodium hydroxide or potassium or alkali metal alkoxides such as sodium methoxide, sodium ethoxide, potassium ethoxide or potassium isopropoxide as catalysts with addition of at least one starter molecule having from 2 to 8, preferably from 2 to 6, reactive hydrogen atoms or by cationic polymerization using Lewis acids, for example antimony pentachloride or boron fluoride etherate, or fuller's earth as catalysts. Tertiary amines can also be used as a catalyst, for example triethylamine, tributylamine, trimethylamine, dimethylethanolamine, imidazole or dimethylcyclohexylamine. For specific use purposes, monofunctional starters may also be incorporated into the polyether structure. Examples of starter molecules for the preparation of polyether polyols (b4) include: water, aliphatic and aromatic, optionally N-monoalkyl- and N,N- and N,N′-dialkyl-substituted diamines having 1 to 4 carbon atoms in the alkyl radical, such as optionally mono- and dialkyl-substituted ethylenediamine, diethylenetriamine, triethylenetetramine, propylene-1,3-diamine, butylene-1,3-diamine or -1,4-diamine, hexamethylene-1,2-diamine, -1,3-diamine, -1,4-diamine, -1,5-diamine, and -1,6-diamine, phenylenediamine, tolylene-2,3-diamine, -2,4-diamine, and -2,6-diamine (TDA), and 4,4′-diamino, 2,4′-diamino, and 2,2′-diaminodiphenylmethane (MDA) and polymeric MDA. Useful starter molecules further include: alkanolamines, for example ethanolamine, N-methyl- and N-ethylethanolamine, dialkanolamines, for example diethanolamine, N-methyl- and N-ethyldiethanolamine, and trialkanolamines, for example triethanolamine, and ammonia. Preference is given to using polyhydric alcohols such as ethanediol, propane-1,2-diol and -2,3-diol, diethylene glycol, dipropylene glycol, butane-1,4-diol, hexane-1,6-diol, glycerol, trimethylolpropane, pentaerythritol, sorbitol, and sucrose, and mixtures thereof. The starter molecules may be used individually or in the form of mixtures. Examples of suitable alkylene oxides are tetrahydrofuran, 1,3-propylene oxide, 1,2- and 2,3-butylene oxide, styrene oxide, and preferably ethylene oxide and 1,2-propylene oxide. The alkylene oxides may be used individually, alternately in succession or as mixtures.

In a preferred embodiment of the process, the further polyether polyol (b4) is present in the polyether polyol (b) in an amount in the range from 0 to 20 further parts by weight, more preferably in the range from 3 to 15 further parts by weight, more preferably 5 to 10 further parts by weight, based on 100 parts by weight of components (b1) and (b2).

In a further preferred embodiment of the process, the polyol mixture (b) contains no further polyether polyol (b4).

### Further Polyether Polyol (b5)

According to a preferred embodiment of the process, the polyol mixture (b) comprises not more than 5 further parts by weight, preferably in the range from 0 to 5 further parts by weight, more preferably in the range from 0 to 3 further parts by weight, more preferably in the range from 0 to 1 further parts by weight, based on 100 parts by weight of components (b1) and (b2), of a further polyether polyol (b5), where (b5) has a hydroxyl value in the range from 10 to 100 mg KOH/g, an OH functionality of at least 2, an ethylene oxide proportion of 0% to 30% by weight based on the content of alkylene oxide, and a proportion of primary OH groups of 0 to 30% based on the total number of OH groups in the polyether polyol (b5).

The hydroxyl value of the further polyether polyol (b5) is preferably in the range from 15 to 90 mg KOH/g, especially in the range from 20 to 80 mg KOH/g, more preferably in the range from 25 to 75 mg KOH/g, most preferably in the range from 35 to 65 mg KOH/g. The proportion of primary OH groups in the further polyether polyol (b5) is preferably in the range from 0 to 25%, especially in the range from 0 to 20%, very particularly preferably in the range from 0 to 15%, especially in the range from 0 to 10%, based on the total number of OH groups in (b5).

The OH functionality of the further polyether polyol (b5) is preferably greater than 2, more preferably at least 2.2, and especially at least 2.4. The OH functionality of the further polyether polyol (b5) is preferably not more than 4, more preferably not more than 3, and especially not more than 2.8. In a preferred embodiment, preferred further polyether polyols (b5) have an OH functionality of more than 2 and not more than 4, more preferably in the range from 2.2 to 4, further preferably in the range from 2.2 to 3, especially in the range from 2.4 to 2.8.

The preparation of polyether polyols (b5) is known from the prior art. Suitable polyols are prepared by known processes, for example by anionic polymerization using as catalysts alkali metal hydroxides, for example sodium hydroxide or potassium hydroxide, or alkali metal alkoxides, for example sodium methoxide, sodium ethoxide, potassium ethoxide or potassium isopropoxide, or by double-metal cyanide catalysis from one or more alkylene oxides having 2 to 4 carbon atoms in the alkylene radical. Such methods of preparation are described in more detail for example in DE 4318120 A1 and WO 2006/034800 A1. Suitable starter compounds for preparing the polyether polyols (b5) are identical to those mentioned for the polyether polyol (b1).

In a preferred embodiment, the polyether polyols in (b5) are prepared on the basis of difunctional, trifunctional or higher functional starters, very particularly preferably glycerol, monoethylene glycol, and/or diethylene glycol. The alkylene oxide of the polyether polyols (b5) preferably comprises propylene oxide. In a first preferred embodiment, propylene oxide is used exclusively as the alkylene oxide. In a further preferred embodiment, propylene oxide is used in admixture with at least one further alkylene oxide. Examples of suitable further alkylene oxides are ethylene oxide, 1,2-butylene oxide, 2,3-butylene oxide, and styrene oxide. The further alkylene oxide is preferably ethylene oxide. The proportion of ethylene oxide in the total amount by weight of alkylene oxide in the polyether polyol (b5) is preferably in the range from 0% to 20% by weight, especially in the range from 0% to 15% by weight, more preferably in the range from 0% to 12% by weight. The alkylene oxide used for the preparation of the polyether polyols (b5) preferably comprises propylene oxide.

Propylene oxide and ethylene oxide are preferably fed into the reaction mixture individually, in admixture, or successively. If the alkylene oxides are added successively, the products produced comprise polyether chains having block structures. The addition of pure propylene oxide or of alkylene oxide mixtures mainly comprising propylene oxide in the last step of the alkoxylation results in products having propylene oxide end blocks. Products having propylene oxide end blocks have a particularly high proportion of secondary OH groups.

According to the invention, it is preferable that in the process for producing a polyurethane foam of the first aspect, the polyol mixture (b) comprises no further polyols besides (b1), (b2), and optionally (b4), the polyol mixture (b) more preferably consisting of (b1), (b2), and optionally (b4).

### Isocyanate Composition (a)

The isocyanate composition (a) comprises at least one polyisocyanate based on diphenylmethane diisocyanate (MDI). Polyisocyanate is in the context of the present invention understood as meaning a polyfunctional isocyanate. Functionality of an isocyanate is in the context of the present invention understood as meaning the number of reactive NCO groups per molecule. A polyfunctional isocyanate here has a functionality of at least 2, i.e. at least two NCO groups. If mixtures of compounds having different functionality are used for a polyisocyanate, the functionality of the components in each case results from the number-weighted average of the functionality of the individual compounds, i.e. functionality is always to be understood as meaning the number-average functionality. The (number-average) functionality of the isocyanate composition (a) is preferably in the range from 2 to 4, more preferably in the range from 2 to 3, more preferably in the range from 2.1 to 2.7. The isocyanate composition (a) preferably consists of at least one MDI-based polyisocyanate. MDI-based polyisocyanates are here diphenylmethane 2,2′-diisocyanate, diphenylmethane 2,4′-diisocyanate, diphenylmethane 4,4′-diisocyanate, and multiring diphenylmethane diisocyanate (multiring MDI, i.e. having 3 or more aryl rings), which is referred to also as polyphenylpolymethylene isocyanate or oligomeric MDI, or mixtures of two or more of the abovementioned compounds, or crude MDI obtained from MDI production. In one embodiment of the process, the abovementioned MDI-based polyisocyanates are used in admixture with further polyisocyanates, especially further aromatic polyisocyanates, preferably tolylene diisocyanate (TDI). In a particularly preferred embodiment, exclusively MDI-based polyisocyanates are reacted, i.e. the isocyanate composition (a) consists to an extent in the range from 99% to 100% by weight, based on the total weight of the isocyanate composition (a), of one or more polyisocyanates based on diphenylmethane diisocyanate (MDI).

Polyfunctional isocyanates or mixtures of a plurality of polyfunctional isocyanates based on MDI are known and are for example marketed by BASF Polyurethanes GmbH under the name Lupranat®.

Preferably, the content of isocyanate groups in the isocyanate composition (a) is in the range from 5 to 10 mmol/g, preferably in the range from 6 to 9 mmol/g, more preferably in the range from 7 to 8.5 mmol/g. It is known to those skilled in the art that the content of isocyanate groups in mmol/g and the so-called equivalent weight in g/equivalent are in a reciprocal relationship. The content of isocyanate groups in mmol/g results from the content in % by weight in accordance with ASTM D-5155-96 A.

The viscosity of the isocyanate composition (a) used may vary within a wide range. Preferably, the isocyanate composition (a) has a viscosity in the range from 10 to 300 mPa·s, more preferably in the range from 20 to 250 mPa·s, in both cases at 25° C.

In a preferred embodiment of the process, the isocyanate composition (a) comprises in the range from 50% to 64% by weight, more preferably in the range from 54% to 62% by weight, more preferably in the range from 57% to 62% by weight, of 4,4′-diphenylmethane diisocyanate (4,4′-MDI), based on 100% by weight of isocyanate composition (a). In a further preferred embodiment of the process, the isocyanate composition (a) comprises in the range from 2% to 10% by weight, more preferably 6% to 9% by weight, of 2,4′-diphenylmethane diisocyanate (2,4′-MDI), based on 100% by weight of isocyanate composition (a). Particularly preferably, the isocyanate composition (a) comprises in the range from 50% to 64% by weight, more preferably in the range from 54% to 62% by weight, more preferably in the range from 57% to 62% by weight, of 4,4′-diphenylmethane diisocyanate (4,4′-MDI), and in each case in the range from 2% to 10% by weight, more preferably 6% to 9% by weight, of 2,4′-diphenylmethane diisocyanate (2,4′-MDI), in each case based on 100% by weight of isocyanate composition (a). In a preferred embodiment of the process, the isocyanate composition (a) comprises in the range from 54% to 62% by weight of 4,4′-diphenylmethane diisocyanate (4,4′-MDI) and in the range from 2% to 10% by weight, more preferably 6% to 9% by weight, of 2,4′-diphenylmethane diisocyanate (2,4′-MDI), in each case based on 100% by weight of isocyanate composition (a). In a further preferred embodiment of the process, the isocyanate composition (a) comprises in the range from 57% to 62% by weight of 4,4′-diphenylmethane diisocyanate (4,4′-MDI) and in the range from 2% to 10% by weight, more preferably 6% to 9% by weight, of 2,4′-diphenylmethane diisocyanate (2,4′-MDI), in each case based on 100% by weight of isocyanate composition (a).

A corresponding composition of the isocyanate composition (a) comprising 4,4′-MDI and/or 2,4′-MDI in the specified amounts leads to a significantly improved, i.e. reduced, air flow resistance (AFR), which in turn results in significantly improved acoustic properties.

In a further embodiment of the process, the isocyanate composition (a) comprises multiring diphenylmethane diisocyanate (multiring MDI) in a content in the range from 30% to 45% by weight based on 100% by weight of isocyanate composition (a).

As already mentioned above, multiring diphenylmethane diisocyanate (multiring MDI) has 3 or more rings and is referred to also as polyphenylpolymethylene isocyanate or oligomeric MDI. “Ring” here means a phenylene group bearing an isocyanate group. Accordingly, both 2.4′-MDI and 4.4′-MDI can also be described as two-ring MDI.

In a preferred embodiment, the isocyanate composition (a) consists of 4,4′-MDI, 2,4′-MDI, and multiring MDI to an extent in the range from 95% to 100% by weight, preferably in the range from 98% to 100% by weight, more preferably in the range from 99% to 100% by weight, based on 100% by weight of isocyanate composition (a), it being further preferable that the reaction of (a), (b), and (c) employs no other isocyanate aside from the polyisocyanates present in the isocyanate composition (a) as mentioned above.

In one embodiment of the process, the reaction employs the isocyanate composition (a) and the polyol mixture (b) in a weight-based ratio (a):(b) in the range from 1:10 to 10:1, preferably in the range from 1:5 to 5:1, preferably in the range from 3:1 to 1:1, more preferably in the range from 2:1 to 1:1, more preferably in the range from 1.2:1 to 1.8:1.

In a preferred embodiment, the isocyanate composition (a) is used wholly or partly in the form of polyisocyanate prepolymers.

These polyisocyanate prepolymers are obtainable through prior reaction of all or some of the above-described polyisocyanates of the isocyanate composition (a) with isocyanate-reactive polymeric compounds to form the isocyanate prepolymer. The reaction is carried out with an excess of the isocyanate composition (a), for example at temperatures in the range from 30 to 100° C., preferably at about 80° C.

Suitable polymeric compounds having isocyanate-reactive groups are known to those skilled in the art and described for example in “Kunststoffhandbuch [Plastics Handbook], volume 7, Polyurethane [Polyurethanes]”, Carl Hanser Verlag, 3rd edition 1993, chapter 3.1.

Suitable polymeric compounds having isocyanate-reactive groups are in principle all known compounds having at least two hydrogen atoms reactive toward isocyanates, for example ones having a functionality in the range from 2 to 8 and having a number-average molecular weight Mn in the range from 400 to 15 000 g/mol. It is thus possible to use for example compounds selected from the group comprising polyether polyols, polyester polyols, and mixtures thereof.

Examples of suitable prepolymers are described in DE 10314762 A1.

Preferred polymeric compounds having isocyanate-reactive groups are polyether polyols according to component (b1) and/or (b2), especially polyether polyols (b1). The abovementioned polymeric compounds are preferably reacted with the above-named polyisocyanates with the latter present in excess.

The NCO content of the prepolymers used is preferably in the range from 20 to 32.5%, more preferably from 25 to 31%. The NCO content is determined in accordance with ASTM D-5155-96 A).

### Catalyst (d)

The process for producing a polyurethane foam of the first aspect comprises the reaction of (a), (b), and (c). In one embodiment, the reaction of (a), (b), and (c) takes place in the presence of at least one catalyst (d).

Catalysts d) greatly accelerate the reaction of the polyether polyols of the polyol mixture (b) and optionally chain extenders (e), crosslinkers (f), and blowing agent composition (c) with the isocyanate composition (a).

In one embodiment of the process, the at least one catalyst (d) comprises incorporable amine catalysts. These have at least one, preferably 1 to 8 and more preferably 1 to 2, isocyanate-reactive groups, such as primary amine groups, secondary amine groups, hydroxyl groups, amides or urea groups, preferably primary amine groups, secondary amine groups, or hydroxyl groups. Incorporable amine catalysts are mostly used for the production of low-emission polyurethanes, which are used in automobile interiors in particular. Such catalysts are known and described for example in EP1888664. They include compounds that, in addition to the isocyanate-reactive groups, preferably have one or more tertiary amino groups. It is preferable when at least one of the tertiary amino groups of the incorporable catalysts bears at least two aliphatic hydrocarbon radicals, preferably having 1 to 10 carbon atoms per radical, more preferably having 1 to 6 carbon atoms per radical. More preferably, the tertiary amino groups bear two radicals independently selected from methyl and ethyl radical plus a further organic radical. Examples of incorporable catalysts that may be used are bis(dimethylaminopropyl)urea, bis(N,N-dimethylaminoethoxyethyl) carbamate, dimethylaminopropylurea, N,N,N-trimethyl-N-hydroxyethylbis(aminopropyl)ether, N,N,N-trimethyl-N-hydroxyethylbis(aminoethyl)ether, diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol) and 1,3-bis(dimethylamino)propan-2-ol, N,N-bis(3-dimethylaminopropyl)-N-isopropanolamine, bis(dimethylaminopropyl)-2-hydroxyethylamine, N,N,N-trimethyl-N-(3-aminopropyl)-bis(aminoethyl)ether, 3-dimethylaminoisopropyl diisopropanolamine, and mixtures thereof.

As well as incorporable amine catalysts, other customary catalysts for producing PU foams may be employed. Examples include amidines, such as 2,3-dimethyl-3,4,5,6-tetrahydropyrimidine, tertiary amines, such as triethylamine, tributylamine, dimethylbenzylamine, N-methyl-, N-ethyl-, and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, and dimethylethanolamine. Likewise suitable are organic metal compounds, preferably organic tin compounds, such as tin(II) salts of organic carboxylic acids, for example tin(II) acetate, tin(II) octanoate, tin(II) ethylhexanoate, and tin(II) laurate, and dialkyltin(IV) salts of organic carboxylic acids, for example dibutyltin diacetate, dibutyltin dilaurate, tin ricinolate, dibutyltin maleate, and dioctyltin diacetate, and also zinc carboxylates such as zinc ricinolate, and also bismuth carboxylates such as bismuth(III) neodecanoate, bismuth 2-ethylhexanoate, and bismuth octanoate, or mixtures thereof. The organic metal compounds can be used alone or preferably in combination with strongly basic amines.

The at least one catalyst (d) is preferably selected from the group consisting of incorporable amine catalyst, amidine, tertiary amine, alkanolamine compound, organic metal compound, and mixtures of two or more of these catalysts.

In a preferred embodiment of the process, the reaction employs catalyst (d) and polyol mixture (b) in a weight-based ratio (d):(b) in the range from 0.001:100 to 5:100, preferably in the range from 0.05:100 to 2:100.

### Further Constituents

In a preferred embodiment of the process, the reaction of (a), (b), and (c) additionally employs at least one further constituent different from (a), (b), (c), and (d), optionally in the presence of at least one catalyst (d), said further constituent preferably being selected from the group consisting of

(e) at least one chain extender,

(f) at least one crosslinker,

(g) at least one additive, and

(h) at least one flame retardant.

It is also possible to omit the chain extender or crosslinker. To modify the mechanical properties, for example hardness, it may however prove advantageous to add chain extenders (e), crosslinkers (f) or else optionally mixtures thereof.

When chain extenders (e) and/or crosslinkers (f) are used, the chain extenders and/or crosslinkers known in the production of polyurethanes may be used. These are preferably low-molecular-weight compounds having isocyanate-reactive functional groups, for example butanediol, 2-methylpropane-1,3-diol, sorbitol, diethanolamine, glycerol, urea, trimethylolpropane, glycols, and diamines. Further possible low-molecular-weight chain extenders and/or crosslinkers are listed for example in “Kunststoffhandbuch [Plastics Handbook], volume 7, Polyurethane [Polyurethanes]”, Carl Hanser Verlag, 3rd edition 1993, chapter 3.4.

Additives (g) that differ from components a) to e) may additionally be employed. All additives known in the production of polyurethanes may be used here. Examples include surface-active substances, foam stabilizers, cell regulators, release agents, fillers, dyes, pigments, flame retardants, hydrolysis stabilizers, and fungistatic and bacteriostatic substances. Such substances are known and are described for example in “Kunststoffhandbuch [Plastics Handbook], volume 7, Polyurethane [Polyurethanes]”, Carl Hanser Verlag, 3rd edition 1993, chapter 3.4.

These may be, for example, surface-active substances that are used to promote homogenization of the starting materials and are optionally also suitable for regulating the cell structure of the foams. Examples include siloxane-oxyalkylene copolymers and other organopolysiloxanes, ethoxylated alkylphenols, ethoxylated fatty alcohols, paraffin oils, castor oil esters or ricinoleic esters, which are used in amounts of from 0.2 to 8, preferably from 0.5 to 5, parts by weight per 100 parts by weight of the polyol mixture (b).

Examples of suitable flame retardants (h) are compounds containing phosphorus and/or halogen atoms, for example tricresyl phosphate, tris(2-chloroethyl) phosphate, tris(chloropropyl) phosphate, 2,2-bis(chloromethyl)trimethylene bis(bis(2-chloroethyl) phosphate), oligomeric organophosphorus compounds (for example Fyrol® PNX, Fyrolflex® RDP), and tris(2,3-dibromopropyl) phosphate. In addition, it is also possible to use inorganic flame retardants, for example antimony trioxide, arsenic oxide, ammonium polyphosphate, expandable graphite, and calcium sulfate, or melamine for making the PU foams flame-resistant. In addition, one or more flame retardants commonly used for polyurethanes may be used. These include halogen-substituted phosphates such as tricresyl phosphate, tris(2-chloroethyl) phosphate, tris(2-chloropropyl) phosphate, tris(1,3-dichloropropyl) phosphate, tris(2,3-dibromopropyl) phosphate, and tetrakis(2-chloroethyl)ethylene diphosphate and/or inorganic flame retardants such as red phosphorus, aluminum oxide hydrate, antimony trioxide, arsenic trioxide, ammonium polyphosphate, calcium sulfate and/or cyanuric acid derivatives, for example melamine.

In one embodiment of the process, at least expandable graphite is used as flame retardant (h). Expandable graphite is generally known. This comprises one or more expandable agents, with the result that considerable expansion occurs under the conditions of a fire. Expandable graphite is produced by known processes. Typically, graphite is first modified with oxidizing agents such as nitrates, chromates or peroxides, or by electrolysis, so as to open the crystal layers; this is followed by the incorporation into the graphite of nitrates or sulfates, which can bring about expansion under given conditions. In a preferred embodiment, expandable graphite is used in combination with ammonium polyphosphate.

In a preferred embodiment of the process, the reaction of (a), (b), (c), optionally in the presence of at least one catalyst (d) as defined above, and optionally one or more of constituents (e), (f), (g), and (h) as defined above, employs less than 1 further part by weight, based on 100 parts by weight of (b1) and (b2), of further polyol aside from the polyols present in the polyol mixture (b) as described above, more preferably none at all. In a further preferred embodiment of the process, the reaction employs only (a), (b), and (c), optionally in the presence of at least one catalyst (d) as defined above, and optionally one or more of constituents (e), (f), (g), and (h) as defined above.

### Blowing Agent Composition (c)

The process for producing a polyurethane foam involves reacting (a) and (b) with a blowing agent composition (c) comprising water. Preferably, the reaction employs the blowing agent composition (c) in a weight-based ratio to the total weight of all isocyanate-reactive compounds used in the reaction in the range from 1:12 to 1:7, preferably in the range from 1:11 to 1:8. More preferably, the blowing agent composition (c) is used in a weight-based ratio to the total weight of (b1), (b2), optionally (b4), optionally catalyst (d), optionally chain extender (e), optionally crosslinker (f), in the range from 1:14 to 1:6, preferably in the range from 1:12 to 1:7, more preferably in the range from 1:11 to 1:8.

In a preferred embodiment of the process, the blowing agent composition (c) comprises water as sole blowing agent, wherein preferably in the range from 99% to 100% by weight, more preferably in the range from 99.5% to 100% by weight, more preferably in the range from 99.9% to 100% by weight, of the blowing agent composition consists of water.

Various processes such as molded foaming or free-rise foaming can be employed to produce PU foams. In a preferred embodiment of the process, free-rise foaming is carried out; more preferably, the process is carried out batchwise or continuously in open foam molds.

In one embodiment of the process, the described starting materials are mixed at temperatures of approximately 15 to 60° C., preferably 20 to 40° C., after which the reaction mixture is allowed to foam (accompanied by expansion) in open, optionally temperature-controlled molds, wherein an increase in temperature sometimes occurs without external influence. After expansion, the PU foam can continue to cure for as long as necessary. In general, a curing time in the range from 1 minute to 24 hours, preferably in the range from 5 minutes to 12 hours, will be sufficient. If necessary, curing can be carried out at elevated temperature, i.e. with external heating. The foam can then can be processed further, for example comminuted. Before processing further, it is however preferable to allow the PU foam obtained to cool to below 80° C., preferably below 50° C. and most preferably to room temperature (25° C.).

### 2nd Aspect—Polyurethane Foam

A second aspect of the invention relates to a polyurethane foam obtained or obtainable by the process according to the first aspect as described above.

A PU foam according to the invention is open-cell and has no appreciable skin. Open-cell means here that, according to DIN ISO 4590, the PU foam has an open-cell content of greater than 50%, preferably greater than 85%, more preferably greater than 90%. In the context of the present invention, a PU foam is preferably a semi-rigid PU foam (semi-rigid polyurethane foam), which is defined as a PU foam that has a compressive stress at 10% compression measured under the conditions in accordance with DIN 7726 (May 1982) in the range from 10 to 80 kPa. The (semi-rigid) PU foam preferably has a compressive stress at 10% compression according to the definition of DIN 7726 (May 1982) in the range from 15 to 80 kPa.

In a preferred embodiment, the polyurethane foam has an air permeability, determined in accordance with DIN EN ISO 7231 (December 2010), of at least 0.02 dm³/s, preferably in the range from 0.02 to 1 dm³/s, more preferably in the range from 0.05 to 1 dm³/s.

In a preferred embodiment, the polyurethane foam has an air flow resistance (AFR) determined in accordance with DIN EN ISO 9053-1 (March 2019) of not more than 10 000 Pa·s/m, preferably in the range from 10 to 10 000 Pa·s/m, more preferably in the range from 100 to 5000 Pa·s/m, more preferably in the range from 100 to 1500 Pa·s/m, more preferably in the range from 100 to 1000 Pa·s/m.

The polyurethane foam particularly preferably has an air permeability, determined in accordance with DIN EN ISO 7231 (December 2010), of at least 0.02 dm³/s, preferably in the range from 0.02 to 1 dm³/s, more preferably in the range from 0.05 to 1 dm³/s, in conjunction with an air flow resistance, determined in accordance with DIN EN ISO 9053-1 (March 2019), of not more than 10 000 Pa·s/m, preferably in the range from 10 to 10 000 Pa·s/m, more preferably in the range from 100 to 5000 Pa·s/m, more preferably in the range from 100 to 1500 Pa·s/m, more preferably in the range from 100 to 1000 Pa·s/m.

In particular the air flow resistance, determined in accordance with DIN EN ISO 9053-1 (March 2019), of not more than 10 000 Pa·s/m makes the PU foam of the present invention particularly well suited as a sound absorption material.

In a preferred embodiment, the polyurethane foam has a compression hardness, determined at 40% compression in the first compression in accordance with DIN EN ISO 3386-1 (October 2015), in the range from 10 to 80 kPa, preferably in the range from 15 to 80 kPa.

With regard to compression hardness, a PU foam is in the context of the present invention defined as a PU foam that at 40% compression in the first compression in accordance with DIN EN ISO 3386-1 (October 2015) has a compression hardness in the range from 10 to 80 kPa, preferably in the range from 10 to 40 kPa, or a compression hardness in the range from 15 to 80 kPa, preferably in the range from 15 to 40 kPa.

In a preferred embodiment, the polyurethane foam has a foam density, determined according to DIN EN ISO 845 (October 2009), of not more than 25 kg/m³, preferably in the range from 10 to 20 kg/m³, more preferably in the range from 12 to 18 kg/m³.

In a preferred embodiment, the polyurethane foam has a resilience, determined according to DIN EN ISO 8307 (December 2018), in the range from 15 to 35%, preferably in the range from 18 to 33%, more preferably in the range from 22 to 30%.

Having a resilience in the stated range means that the PU foam differs significantly from elastic foams, which have resiliences determined according to DIN EN ISO 8307 (December 2018) of more than 35%, usually in the range from 45 to 70%, and from viscoelastic foams, which have resiliences determined according to DIN EN ISO 8307 (December 2018) of at most 15%, usually in the range from 5 to 12%.

It is standard practice in the production of viscoelastic foams to employ at least 5% by weight, based on the total weight of all polyols, of polyols having average OH values, i.e. hydroxyl values in the range from 150-250 mg KOH/g. These are reacted with polydiols and optionally monools. By contrast, the production of the semi-rigid PU foams of the invention employs less than 5 further parts by weight, preferably in the range from 0 to 4.9 further parts by weight, more preferably in the range from 0 to 3 further parts by weight, more preferably in the range from 0 to 1 further parts by weight, based on 100 parts by weight of components (b1) and (b2), of a further polyol having a hydroxyl value in the range from 150 to 250 mg KOH/g. Likewise, less than 5 further parts by weight, preferably in the range from 0 to 4.9 further parts by weight, more preferably in the range from 0 to 3 further parts by weight, more preferably in the range from 0 to 1 further parts by weight, based on 100 parts by weight of components (b1) and (b2), of a polydiol are used.

The PU foam is thermoformable. “Thermoformable” is in the context of the present invention understood as meaning that the foam is irreversibly deformable, preferably at temperatures in the range from 100 to 250° C., more preferably in the range from 120 to 200° C., preferably in a suitable mold. During thermoforming, it is preferably compressed by at least 50%, preferably by 70 to 95%, of its thickness, i.e. compressed to a thickness of max. 50%, preferably to a thickness in the range from 5 to 30%, of its thickness prior to thermoforming.

“Irreversible deformation” is in the context of this invention understood as meaning that the thickness of the thermoformed PU foam does not change, preferably that, in the temperature range from −70 to +70° C. in the absence of applied pressure and at constant temperature and humidity over a period of at least one month, starting at a time t₀, it does not change at any desired point in the thermoformed polyurethane foam by more than 5%, preferably by more than 2%, based on the thickness of the thermoformed PU foam at time t₀. The structure produced by the thermoforming process also does not undergo any change visible to the eye.

The thermoformed PU foams additionally have the same acoustic properties, especially with regard to air flow resistance, as those described above for PU foam.

### 3rd Aspect—Use as a Sound Absorption Material

A third aspect of the present invention relates to the use of a polyurethane foam (PU foam) according to the second aspect as a sound absorption material, preferably in a means of transport, preferably in a mobile means of transport, more preferably in a mobile means of transport for moving people and/or goods, the means of transport more preferably being selected from the group consisting of aircraft, ship, rail vehicle, truck, and automobile.

According to a preferred embodiment, the PU foam is used as a component of cladding in the interior, engine compartment or exterior of a means of transport.

According to a further preferred embodiment, the PU foam is used in the interior of an automobile as cladding for a wall, a door, a roof or in the engine compartment.

### 4th Aspect—Sound Absorption Material

A fourth aspect of the invention relates to a sound absorption material comprising a polyurethane foam according to the second aspect, preferably consisting of a polyurethane foam according to the second aspect.

### 5th Aspect—Use of a Polyol Mixture (b)

In a fifth aspect, the invention relates to the use of a polyol mixture (b) comprising:

b1) 50% to 85% by weight of at least one polyether polyol having a hydroxyl value in the range from 10 to 60 mg KOH/g, an OH functionality of more than 2, and an ethylene oxide proportion in the range from 50% to 100% by weight based on the alkylene oxide content of the at least one polyether polyol,

(b2) 15% to 50% by weight of at least one polyether polyol having a hydroxyl value in the range from 10 to 100 mg KOH/g, an OH functionality of more than 2, an ethylene oxide proportion in the range from 2% to 30% by weight based on the alkylene oxide content of the at least one polyether polyol, and a proportion of primary OH groups of 40 to 100% based on the total number of OH groups in the at least one polyether polyol, in each case based on the total amount by weight of constituents (b1) and (b2), which adds up to 100% by weight,

and

(b3) 0 to 20 further parts by weight of an optionally derivatized filler, based on 100 parts by weight of components (b1) and (b2), optionally present as a constituent of a graft polyol based on one or more of components (b1) and (b2);

for the production of a polyurethane foam, preferably a polyurethane foam having at least one of the following properties:
an air permeability determined in accordance with DIN EN ISO 7231 (December 2012) of at least 0.02 dm³/s, preferably in the range from 0.02 to 1 dm³/s, more preferably in the range from 0.05 to 1 dm³/s;
an air flow resistance (AFR) determined in accordance with DIN EN ISO 9053-1 (March 2019) of not more than 10 000 Pa·s/m, preferably in the range from 10 to 10 000 Pa·s/m, more preferably in the range from 100 to 5000 Pa·s/m, more preferably in the range from 100 to 1500 Pa·s/m, more preferably in the range from 100 to 1000 Pa·s/m;
a compression hardness, determined at 40% compression in the first compression in accordance with DIN EN ISO 3386-1 (October 2015), in the range from 10 to 80 kPa, preferably in the range from 15 to 80 kPa;
a foam density, determined according to DIN EN ISO 845 (October 2009), of not more than 25 kg/m³, preferably in the range from 10 to 20 kg/m³, more preferably in the range from 12 to 18 kg/m³;
a resilience, determined according to DIN EN ISO 8307 (December 2018), in the range from 15 to 35%, preferably in the range from 18 to 33%, more preferably in the range from 22 to 30%.

The present invention is illustrated in more detail by the following embodiments and combinations of embodiments, which result from the corresponding dependency references and other references. It should be noted here that in all cases in which a range of embodiments is mentioned, for example in the context of an expression such as “embodiment (4), which specificizes embodiments (1) to (3)”, each embodiment in this range is deemed to be explicitly disclosed to a person skilled in the art, i.e. this expression is to be understood by a person skilled in the art as synonymous with “embodiment (4), which specificizes one (any) of embodiments (1), (2), (3), and (4)”. In addition, it is explicitly noted that the following set of embodiments is not the set of claims that determines the scope of protection, but instead constitutes an appropriately structured part of the description directed to general and preferred aspects of the invention.

According to one embodiment (1), the invention relates to a process for producing a polyurethane foam, comprising the reaction of:

(a) an isocyanate composition comprising at least one polyisocyanate based on diphenylmethane diisocyanate;

(b) a polyol mixture comprising
b1) 50% to 85% by weight of at least one polyether polyol having a hydroxyl value in the range from 10 to 60 mg KOH/g, an OH functionality of more than 2, and an ethylene oxide proportion in the range from 50% to 100% by weight based on the alkylene oxide content of the at least one polyether polyol,
(b2) 15% to 50% by weight of at least one polyether polyol having a hydroxyl value in the range from 10 to 100 mg KOH/g, an OH functionality of more than 2, an ethylene oxide proportion in the range from 2% to 30% by weight based on the alkylene oxide content of the at least one polyether polyol, and a proportion of primary OH groups of 40 to 100% based on the total number of OH groups in the at least one polyether polyol,
   in each case based on the total amount by weight of constituents (b1) and (b2), which adds up to 100% by weight,
   and
(b3) 0 to 20 further parts by weight of an optionally derivatized filler, based on 100 parts by weight of components (b1) and (b2), optionally present as a constituent of a graft polyol based on one or more of components (b1) and (b2);

(c) a blowing agent composition comprising water;

wherein the reaction employs the blowing agent composition (c) in a weight-based ratio of the weight of blowing agent composition (c) to the total weight of all isocyanate-reactive compounds used in the reaction in the range from 1:14 to 1:6;

wherein a polyurethane foam having a foam density, determined according to DIN EN ISO 845 (October 2009), of not more than 25 kg/m³ and a compression hardness, determined at 40% compression in the first compression in accordance with DIN EN ISO 3386-1 (October 2015), in the range from 10 to 80 kPa is obtained.

A preferred embodiment (2), which specificizes embodiment (1), relates to the process wherein the polyol mixture (b) comprises the at least one polyether polyol (b1) in the range from 60% to 82% by weight, preferably in the range from 65% to 80% by weight, more preferably in the range from 68% to 78% by weight, more preferably in the range from 70% to 75% by weight, based on the total amount by weight of constituents (b1) and (b2), which adds up to 100% by weight.

A preferred embodiment (3), which specificizes embodiment (1) or (2), relates to the process wherein the polyol mixture (b) comprises the at least one polyether polyol (b2) in the range from 18% to 40% by weight, preferably in the range from 21% to 32% by weight, even more preferably 25% to 30% by weight, based on the total amount by weight of components (b1) and (b2), which adds up to 100% by weight.

A preferred embodiment (4), which specificizes any of embodiments (1) to (3), relates to the process wherein the optionally derivatized filler according to (b3) is present as a constituent of a graft polyol based on a polyether polyol (b2), preferably in an amount in the range from 0.01 to 20 further parts by weight, more preferably in the range from 1 to 10 further parts by weight, based on 100 parts by weight of components (b1) and (b2),

and/or

the filler according to (b3) is present as a dispersion in a polyether polyol (b2), preferably in an amount in the range from 0.01 to 20 further parts by weight, more preferably in the range from 1 to 10 further parts by weight, more preferably in the range from 3 to 8 further parts by weight, based on 100 parts by weight of components (b1) and (b2).

A preferred embodiment (5), which specificizes any of embodiments (1) to (4), relates to the process wherein the optionally derivatized filler according to (b3) comprises a polymer, preferably consists of the polymer to an extent of from 95% to 100% by weight, more preferably to an extent of from 98% to 100% by weight, more preferably to an extent of from 99% to 100% by weight, the polymer preferably being selected from the group consisting of (co)polymers based on styrene-acrylonitrile and/or acrylonitrile, more preferably at least poly(styrene-acrylonitrile) (SAN).

A preferred embodiment (6), which specificizes any of embodiments (1) to (5), relates to the process wherein the polyether polyol (b1) has an OH functionality in the range from 2.2 to 8, preferably in the range from 2.2 to 4, more preferably in the range from 2.4 to 3.3.

A preferred embodiment (7), which specificizes any of embodiments (1) to (6), relates to the process wherein the polyether polyol (b1) has a proportion of primary OH groups in the range from 40 to 100% based on the total number of OH groups in the polyether polyol (b1).

A preferred embodiment (8), which specificizes any of embodiments (1) to (7), relates to the process wherein the polyether polyol (b2) has a proportion of primary OH groups in the range from 50 to 100%, preferably in the range from 70% up to 90%, based on the total number of OH groups in the polyether polyol (b2).

A preferred embodiment (9), which specificizes any of embodiments (1) to (8), relates to the process wherein the polyether polyol (b2) has an OH functionality in the range from 2.2 to 8, preferably in the range from 2.2 to 4, more preferably in the range from 2.4 to 3.3.

A preferred embodiment (10), which specificizes any of embodiments (1) to (9), relates to the process wherein the isocyanate composition (a) comprises in the range from 50% to 64% by weight, more preferably in the range from 54% to 62% by weight, more preferably in the range from 57% to 62% by weight, of 4,4′-diphenylmethane diisocyanate (4,4′-MDI), based on 100% by weight of isocyanate composition (a).

A preferred embodiment (11), which specificizes any of embodiments (1) to (10), relates to the process wherein the isocyanate composition (a) comprises in the range from 2% to 10% by weight of 2,4′-diphenylmethane diisocyanate (2,4′-MDI) based on 100% by weight of isocyanate composition (a).

A preferred embodiment (12), which specificizes any of embodiments (1) to (11), relates to the process wherein the isocyanate composition (a) comprises from 30% to 45% by weight of multiring diphenylmethane diisocyanate (multiring MDI), based on 100% by weight of isocyanate composition (a).

A preferred embodiment (13), which specificizes any of embodiments (1) to (12), relates to the process wherein the isocyanate composition (a) consists to an extent in the range from 95% to 100% by weight, preferably in the range from 98% to 100% by weight, more preferably in the range from 99% to 100% by weight, of 4,4′-MDI, 2,4′-MDI, and multiring MDI, based on 100% by weight of isocyanate composition (a), it being further preferable that the reaction of (a), (b), and (c) employs no other isocyanate aside from the polyisocyanates present in the isocyanate composition (a) according to any of embodiments 1 to 12.

A preferred embodiment (14), which specificizes any of embodiments (1) to (13), relates to the process wherein the reaction employs the isocyanate composition (a) and the polyol mixture (b) in a weight-based ratio (a):(b) in the range from 1:10 to 10:1, preferably in the range from 1:5 to 5:1, preferably in the range from 3:1 to 1:1, more preferably in the range from 2:1 to 1:1, more preferably in the range from 1.2:1 to 1.8:1.

A preferred embodiment (15), which specificizes any of embodiments (1) to (14), relates to the process wherein the polyol mixture (b) further comprises:

(b4) at least one further polyether polyol that differs from the at least one polyether polyol according to (b1) and from the at least one polyether polyol according to (b2) and has a hydroxyl value of more than 350 mg KOH/g, preferably in the range from 350 to 800 mg KOH/g, preferably in an amount in the range from 0 to 20 further parts by weight, more preferably in the range from 3 to 15 further parts by weight, more preferably 5 to 10 further parts by weight, based on 100 parts by weight of components (b1) and (b2).

A preferred embodiment (16), which specificizes any of embodiments (1) to (15), relates to the process wherein the polyol mixture (b) comprises not more than 5 further parts by weight, preferably in the range from 0 to 5 further parts by weight, more preferably in the range from 0 to 3 further parts by weight, more preferably in the range from 0 to 1 further parts by weight, based on 100 parts by weight of components (b1) and (b2), of a further polyether polyol (b5), wherein (b5) has a hydroxyl value in the range from 10 to 100 mg KOH/g, an OH functionality of at least 2, an ethylene oxide proportion of 0% to 30% by weight based on the content of alkylene oxide, and a proportion of primary OH groups of 0 to 30% based on the total number of OH groups in the polyether polyol (b5).

A preferred embodiment (17), which specificizes any of embodiments (1) to (16), relates to the process wherein the polyol mixture (b) comprises no further polyols besides (b1), (b2), and optionally (b4), the polyol mixture (b) preferably consisting of (b1), (b2), and optionally b4).

A preferred embodiment (18), which specificizes any of embodiments (1) to (17), relates to the process wherein the reaction of (a), (b), and (c) takes place in the presence of at least one catalyst (d).

A preferred embodiment (19), which specificizes any of embodiments (1) to (18), relates to the process wherein the at least one catalyst (d) is selected from the group consisting of incorporable amine catalyst, amidine, tertiary amine, alkanolamine compound, organic metal compound, and mixtures of two or more of these catalysts, wherein the reaction employs catalyst (d) and polyol mixture (b) in a weight-based ratio (d):(b) in the range from 0.001:100 to 5:100, preferably in the range from 0.05:100 to 2:100.

A preferred embodiment (20), which specificizes any of embodiments (1) to (19), relates to the process wherein the reaction of (a), (b), and (c), optionally in the presence of at least one catalyst (d), additionally employs at least one further constituent different from (a), (b), (c), and (d), this being selected from the group consisting of

(e) at least one chain extender,

(f) at least one crosslinker,

(g) at least one additive, and

(h) at least one flame retardant.

A preferred embodiment (21), which specificizes any of embodiments (1) to (20), relates to the process wherein the reaction of (a), (b), (c), optionally in the presence of at least one catalyst (d) as defined as defined in embodiment (18) or (19), and optionally one or more of constituents (e), (f), (g), and (h) as defined in embodiment (20), employs less than 1 further part by weight, based on 100 parts by weight of (b1) and (b2), of further polyol aside from the polyols present in the polyol mixture (b) according to any of embodiments (1) to (17), more preferably none at all.

A preferred embodiment (22), which specificizes any of embodiments (1) to (21), relates to the process wherein the reaction employs only (a), (b), and (c), optionally in the presence of at least one catalyst (d) as defined in embodiment (17), and optionally one or more of constituents (e), (f), (g), and (h) as defined in embodiment (18).

A preferred embodiment (23), which specificizes any of embodiments (1) to (22), relates to the process wherein the reaction employs the blowing agent composition (c) in a weight-based ratio to the total weight of all isocyanate-reactive compounds used in the reaction in the range from 1:12 to 1:7, preferably in the range from 1:11 to 1:8, it being further preferable that the blowing agent composition (c) is used in a weight-based ratio to the total weight of (b1), (b2), optionally (b4), optionally catalyst (d), optionally chain extender (e), optionally crosslinker (f), in the range from 1:14 to 1:6, preferably in the range from 1:12 to 1:7, more preferably in the range from 1:11 to 1:8.

A preferred embodiment (24), which specificizes any of embodiments (1) to (23), relates to the process wherein the blowing agent composition (c) comprises water as sole blowing agent, wherein preferably in the range from 99% to 100% by weight, more preferably in the range from 99.5% to 100% by weight, more preferably in the range from 99.9% to 100% by weight, of the blowing agent composition consists of water.

A preferred embodiment (25), which specificizes any of embodiments (1) to (24), relates to the process wherein free-rise foaming is carried out.

An embodiment (26) relates to a polyurethane foam obtained or obtainable by the process according to any of embodiments (1) to (25).

A preferred embodiment (27), which specificizes embodiment (26), relates to the polyurethane foam, which has an air permeability determined in accordance with DIN EN ISO 7231 (December 2010) of at least 0.02 dm³/s, preferably in the range from 0.02 to 1 dm³/s, more preferably in the range from 0.05 to 1 dm³/s.

A preferred embodiment (28), which specificizes embodiment (26) or (27), relates to the polyurethane foam, which has an air flow resistance (AFR) determined in accordance with DIN EN ISO 9053-1 (March 2019) of not more than 10 000 Pa·s/m, preferably in the range from 10 to 10 000 Pa·s/m, more preferably in the range from 100 to 5000 Pa·s/m, more preferably in the range from 100 to 1500 Pa·s/m, more preferably in the range from 100 to 1000 Pa·s/m.

A preferred embodiment (29), which specificizes any of embodiments (26) to (28), relates to the polyurethane foam, which has a compression hardness, determined at 40% compression in the first compression in accordance with DIN EN ISO 3386-1 (October 2015), in the range from 10 to 80 kPa, preferably in the range from 15 to 80 kPa.

A preferred embodiment (30), which specificizes any of embodiments (26) to (29), relates to the polyurethane foam, which has a foam density, determined according to DIN EN ISO 845 (October 2009), of not more than 25 kg/m³, preferably in the range from 10 to 20 kg/m³, more preferably in the range from 12 to 18 kg/m³.

A preferred embodiment (31), which specificizes any of embodiments (26) to (30), relates to the polyurethane foam which has a resilience determined according to DIN EN ISO 8307 (December 2018) in the range from 15 to 35%, preferably in the range from 18 to 33%, more preferably in the range from 22 to 30%.

An embodiment (32) of the invention relates to the use of a polyurethane foam in accordance with any of embodiments (26) to (31) as a sound absorption material, preferably in a means of transport, preferably in a mobile means of transport, more preferably in a mobile means of transport for moving people and/or goods, the means of transport more preferably being selected from the group consisting of aircraft, ship, rail vehicle, truck, and automobile.

A preferred embodiment (33), which specificizes embodiment (32), relates to the use as a component of cladding in the interior, engine compartment or exterior of a means of transport.

A preferred embodiment (34), which specificizes embodiment (32) or (33), relates to the use in the interior of an automobile as cladding for a wall, a door, a roof or in the engine compartment.

An embodiment (35) of the invention relates to a sound absorption material comprising a polyurethane foam according to any of embodiments (26) to (31), preferably consisting of a polyurethane foam according to any of embodiments (26) to (31).

An embodiment (36) of the invention relates to the use of a polyol mixture (b) comprising:

b1) 50% to 85% by weight of at least one polyether polyol having a hydroxyl value in the range from 10 to 60 mg KOH/g, an OH functionality of more than 2, and an ethylene oxide proportion in the range from 50% to 100% by weight based on the alkylene oxide content of the at least one polyether polyol,

(b2) 15% to 50% by weight of at least one polyether polyol having a hydroxyl value in the range from 10 to 100 mg KOH/g, an OH functionality of more than 2, an ethylene oxide proportion in the range from 2% to 30% by weight based on the alkylene oxide content of the at least one polyether polyol, and a proportion of primary OH groups of 40 to 100% based on the total number of OH groups in the at least one polyether polyol, in each case based on the total amount by weight of constituents (b1) and (b2), which adds up to 100% by weight,

and

(b3) 0 to 20 further parts by weight of an optionally derivatized filler, based on 100 parts by weight of components (b1) and (b2), optionally present as a constituent of a graft polyol based on one or more of components (b1) and (b2);

for the production of a polyurethane foam, preferably a polyurethane foam having at least one of the following properties:
an air permeability determined in accordance with DIN EN ISO 7231 (December 2012) of at least 0.02 dm³/s, preferably in the range from 0.02 to 1 dm³/s, more preferably in the range from 0.05 to 1 dm³/s;
an air flow resistance (AFR) determined in accordance with DIN EN ISO 9053-1 (March 2019) of not more than 10 000 Pa·s/m, preferably in the range from 10 to 10 000 Pa·s/m, more preferably in the range from 100 to 5000 Pa·s/m, more preferably in the range from 100 to 1500 Pa·s/m, more preferably in the range from 100 to 1000 Pa·s/m;
a compression hardness, determined at 40% compression in the first compression in accordance with DIN EN ISO 3386-1 (October 2015), in the range from 10 to 80 kPa, preferably in the range from 15 to 80 kPa;
a foam density, determined according to DIN EN ISO 845 (October 2009), of not more than 25 kg/m³, preferably in the range from 10 to 20 kg/m³, more preferably in the range from 12 to 18 kg/m³;
a resilience, determined according to DIN EN ISO 8307 (December 2018), in the range from 15 to 35%, preferably in the range from 18 to 33%, more preferably in the range from 22 to 30%.

In addition, it is explicitly noted that the above set of embodiments is not the set of claims that determines the scope of protection, but instead constitutes an appropriately structured part of the description directed to general and preferred aspects of the invention.

The invention is elucidated in more detail hereinbelow with reference to examples, without being restricted thereto.

### EXAMPLES

### 1 Measurement Methods

TABLE 1
Standards used for foam tests

| Property | Unit | Standard | Year-month |
|---|---|---|---|
| Foam density | kg/m³ | DIN EN ISO 845 | 2009 October |
| Compression | kPa | DIN EN ISO 3386-1 | 2015 October |
| hardness | | | |
| 40% (in first | | | |
| compression) | | | |
| Tensile strength | kPa | DIN EN ISO 1798 | 2008 April |
| Elongation at break | % | DIN EN ISO 1798 | 2008 April |
| Resilience | % | DIN EN ISO 8307 | 2018 December |
| Air permeability | dm³/s | DIN EN ISO 7231 | 2010 December |
| AFR* | Pa · s/m | DIN EN ISO 9053-1 | 2019 March |

*Air flow resistance

### 2 Starting Materials

Polyol A: OH value 42 mg KOH/g, polyether alcohol having 77% primary OH groups based on propylene oxide and ethylene oxide (72% by weight), starter glycerol. The average functionality was 2.7.

Polyol B: OH value 29 mg KOH/g, polyether alcohol having 79% primary OH groups based on propylene oxide and ethylene oxide (14% by weight), starter glycerol. The average functionality was 2.7.

Polyol C: OH value 35 mg KOH/g, polyether alcohol having 72% primary OH groups based on propylene oxide and ethylene oxide (13% by weight), starter glycerol. The average functionality was 2.7.

Polyol D: OH value 20 mg KOH/g, graft polyol having a 45% content of filler (styrene-acrylonitrile, SAN), polyol C as carrier polyol. The average functionality was 2.7.

Polyol E: OH value 420 mg KOH/g, polyether alcohol based on propylene oxide (78% by weight), starter glycerol. The average functionality was 3.0.

DEOA: Diethanolamine 80% by weight in water

Sorbidex 70%: 70% by weight sorbitol in water

Jeffcat DPA: Amine catalyst (Huntsmann)

Kosmos 29: Tin catalyst (Evonik)

DABCO DC 198: Silicone stabilizer (Evonik)

Expandable graphite: Expandable (exfoliated) graphite

Exolit AP 422: Ammonium polyphosphate (Clariant)

Isocyanate A: NCO content 31.5% by weight, multiring diphenylmethane diisocyanate (multiring MDI) having a functionality of 2.7

Isocyanate B: NCO content 33.5% by weight, 4,4′-diphenylmethane diisocyanate (4,4′-MDI) (˜99% by weight)

Isocyanate C: NCO content 33.5% by weight, isomer mixture of 4,4′-MDI (˜50% by weight) and 2,4′-diphenylmethane diisocyanate (2,4′-MDI) (˜50% by weight)

### 3 Examples and Comparative Examples

Polyisocyanate compositions (a)-1 to (a)-4 were formed from isocyanates A, B, and C by mixing. Table 2 shows the composition of (a)-1 to (a)-4 in parts by weight or in % by weight calculated from the parts by weight of the respective polyisocyanate, based on 100% by weight of the polyisocyanate composition.

TABLE 2
Composition of the employed polyisocyanate composition (a)-1 to (a)-4 in parts by weight
or in % by weight.

| | | | | | | Multiring |
|---|---|---|---|---|---|---|
| | | | | 4,4'-MDI | 2,4'-MDI | MDI |
| | Isocyanate | Isocyanate | Isocyanate | [% by | [% by | [% by |
| | A | B | C | weight] | weight] | weight] |
| Polyisocyanate | 62.5 | 12.2 | 25.3 | 47.9 | 15.2 | 36.4 |
| composition (a)-1 | | | | | | |
| Polyisocyanate | 72.5 | 21.4 | 6.1 | 51.3 | 6.4 | 42.2 |
| composition (a)-2 | | | | | | |
| Polyisocyanate | 69.1 | 24.1 | 6.8 | 53.0 | 6.6 | 40.2 |
| composition (a)-3 | | | | | | |
| Polyisocyanate | 65.6 | 26.8 | 7.6 | 54.7 | 6.9 | 38.2 |
| composition (a)-4 | | | | | | |
| Polyisocyanate | 58.8 | 32.1 | 9.1 | 58.2 | 7.4 | 34.2 |
| composition (a)-5 | | | | | | |

The starting materials were foamed to form a semi-rigid polyurethane foam in the amounts stated in Tables 3, 5, and 7 using water as the blowing agent.

For this, a mixture was in each case produced by mixing the specified polyols, catalysts, and additives. The respective mixture was mixed at the specified index with the polyisocyanate composition (a)-1 to (a)-4 or (a)-5 specified in the particular case, and placed in an open mold and left there for 24 hours. After 24 hours, the semi-rigid polyurethane foams obtained were sawn to obtain samples. All components were used at room temperature.

Tables 3, 5, and 7 show the amounts of polyols A-E used in parts by weight for each mixture plus, for components (b1) and (b2) of the polyol mixture (b) according to embodiment 1, the correspondingly calculated amounts in % by weight, based on the sum (b1)+(b2)=100% by weight, which are shown in the third-last and second-last rows respectively. In the form of a graft polyol with proportions of component (b2), optionally derivatized filler (b3) was present as a constituent of polyol D and the amount in parts by weight based on 100 parts by weight (b1)+(b2) is additionally shown in Tables 3 and 5, in the last row in each case.

The properties of the semi-rigid polyurethane foams thus obtained are given in Tables 4, 6, and 8 below. C1-C6 and C7-C9 were comparative examples, 1-12 and 13 to 17 represented examples according to the invention.

TABLE 3
Amounts used and constituents for production of the freely-foamed semi-rigid polyurethane
foams (total weight of the employed components polyisocyanate composition, polyols, and
additives approx. 1.3 kg). Amounts specified in parts by weight unless otherwise stated.

| | C1 | C2 | C3 | 1 | 2 | 3 | 4 | 5 |
|---|---|---|---|---|---|---|---|---|
| Polyol A | | 25 | 80 | 50 | 60 | 70 | 70 | 70 |
| Polyol B | 85 | 60 | 5 | 35 | 25 | 15 | 15 | 15 |
| Polyol D | 15 | 15 | 15 | 15 | 15 | 15 | 15 | 15 |
| Polyol E | 5 | 5 | 5 | 5 | 5 | 5 | 5 | 5 |
| Polyisocyanate | 0 | 0 | 0 | 0 | 0 | 0 | 147.8 | 0 |
| composition (a)-1 | | | | | | | | |
| Polyisocyanate | 146.7 | 147.4 | 149.0 | 148.1 | 148.4 | 148.7 | 0 | 0 |
| composition (a)-2 | | | | | | | | |
| Polyisocyanate | 0 | 0 | 0 | 0 | 0 | 0 | 0 | 148.1 |
| composition (a)-4 | | | | | | | | |
| DC 198 | 1.5 | 1.5 | 1.5 | 1.5 | 1.5 | 1.5 | 1.5 | 1.5 |
| DEOA | 1.8 | 1.8 | 1.8 | 1.8 | 1.8 | 1.8 | 1.8 | 1.8 |
| Jeffcat DPA | 0.6 | 0.6 | 0.6 | 0.6 | 0.6 | 0.6 | 0.6 | 0.6 |
| Kosmos 29 | 0.05 | 0.05 | 0.05 | 0.05 | 0.05 | 0.05 | 0.05 | 0.05 |
| Water total* | 10 | 10 | 10 | 10 | 10 | 10 | 10 | 10 |
| Index | 90 | 90 | 90 | 90 | 90 | 90 | 90 | 90 |
| Polyol mixture (b) in % | | | | | | | | |
| by weight based on | | | | | | | | |
| (b1) + (b2) = 100% by | | | | | | | | |
| weight: | | | | | | | | |
| (b1) [% by weight] | 0 | 26.8 | 85.8 | 53.6 | 64.3 | 75.1 | 75.1 | 75.1 |
| (b2) [% by weight] | 100 | 73.2 | 14.2 | 46.4 | 35.7 | 24.9 | 24.9 | 24.9 |
| Further parts by | 6.8 | 6.8 | 6.8 | 6.8 | 6.8 | 6.8 | 6.8 | 6.8 |
| weight of filler SAN | | | | | | | | |
| (b3) | | | | | | | | |

*“Water total” means the sum of added water and the water present in other components.

Foam C3 showed pronounced settling and could not be characterized.

TABLE 4
Mechanical properties of the semi-rigid foams obtained.

| | C1 | C2 | C3 | 1 | 2 | 3 | 4 | 5 |
|---|---|---|---|---|---|---|---|---|
| Foam density [kg/m³] | 15.6 | 14.4 | — | 13.6 | 14.5 | 16.3 | 17.2 | 17.2 |
| Compression hardness | 35.5 | 24.1 | — | 19.7 | 20.9 | 29.0 | 23.5 | 27.0 |
| 40% [kPa] | | | | | | | | |
| (in first compression) | | | | | | | | |
| Tensile strength [kPa] | 99 | 59 | — | 72 | 55 | 80 | 74 | 77 |
| Elongation at break [%] | 23 | 32 | — | 38 | 36 | 22 | 23 | 24 |
| Resilience [%] | 18 | 15 | — | 22 | 22 | 24 | 30 | 30 |
| Air permeability [dm³/s] | 0.004 | 0.007 | — | 0.063 | 0.027 | 0.168 | 0.147 | 0.318 |
| AFR [Pa · s/m] | 59400 | 41700 | — | 2780 | 1200 | 813 | 1350 | 511 |

“—” Not determined

It was readily apparent that the inventive semi-rigid foams of examples 1 to 5 had considerably better acoustic properties in respect of sound absorption than comparative examples C1 to C3. For instance, the air permeability for the semirigid foams of examples 1 to 5, determined in accordance with DIN EN ISO 7231, was at least 0.02 dm³/s, whereas the semi-rigid foams of comparative examples C1 and C2 had air permeabilities of considerably less than 0.02 dm³/s. The inventive semi-rigid foams of examples 1 to 5 likewise had considerably better values in respect of air flow resistance, determined in accordance with DIN EN ISO 9053: 1-5 had AFR values of at most 10 000 Pa·s/m, whereas C1 and C2 had AFR values of well above 10 000 Pa·s/m, and in fact of well above 40 000 Pa·s/m.

TABLE 5
Amounts used and constituents for production of the freely-foamed semi-rigid polyurethane
foams (total weight of the employed components polyisocyanate composition,
polyols/polyol mixture, and additives approx. 1.6 kg). Amounts specified in parts by
weight unless otherwise stated.

| | C4 | C5 | C6 | 6 | 7 | 8 | 9 | 10 | 11 | 12 |
|---|---|---|---|---|---|---|---|---|---|---|
| Polyol A | 0 | 25 | 80 | 50 | 60 | 70 | 70 | 70 | 70 | 75 |
| Polyol B | 85 | 60 | 5 | 35 | 25 | 15 | 15 | 15 | 30 | 25 |
| Polyol D | 15 | 15 | 15 | 15 | 15 | 15 | 15 | 15 | 0 | 0 |
| Polyol E | 5 | 0 | 5 | 5 | 5 | 5 | 5 | 5 | 5 | 5 |
| Polyisocyanate | 0 | 0 | 0 | 0 | 0 | 0 | 165.5 | 0 | 0 | 0 |
| composition (a)-1 | | | | | | | | | | |
| Polyisocyanate | 164.9 | 165.3 | 167.0 | 167.1 | 166.8 | 166.6 | 0 | 0 | 166.8 | 166.7 |
| composition (a)-2 | | | | | | | | | | |
| Polyisocyanate | 0 | 0 | 0 | 0 | 0 | 0 | 0 | 166.2 | 0 | 0 |
| composition (a)-3 | | | | | | | | | | |
| Expandable | 20 | 20 | 20 | 20 | 20 | 20 | 20 | 20 | 20 | 20 |
| graphite | | | | | | | | | | |
| Exolit AP 422 | 5 | 5 | 5 | 5 | 5 | 5 | 5 | 5 | 5 | 5 |
| DC 198 | 1.5 | 1.5 | 1.5 | 1.5 | 1.5 | 1.5 | 1.5 | 1.5 | 1.5 | 1.5 |
| Sorbidex | 0.5 | 0.5 | 0.5 | 0.5 | 0.5 | 0.5 | 0.5 | 0.5 | 0.5 | 0.5 |
| DEOA | 1.8 | 1.8 | 1.8 | 1.8 | 1.8 | 1.8 | 1.8 | 1.8 | 1.8 | 1.8 |
| Jeffcat DPA | 0.6 | 0.6 | 0.6 | 0.6 | 0.6 | 0.6 | 0.6 | 0.6 | 0.6 | 0.6 |
| Kosmos 29 | 0.05 | 0.05 | 0.05 | 0.05 | 0.05 | 0.05 | 0.05 | 0.05 | 0.05 | 0.05 |
| Water total* | 12 | 12 | 12 | 12 | 12 | 12 | 12 | 12 | 12 | 12 |
| Index | 85 | 85 | 85 | 85 | 85 | 85 | 85 | 85 | 85 | 85 |
| Polyol mixture | | | | | | | | | | |
| (b) in % by | | | | | | | | | | |
| weight based | | | | | | | | | | |
| on (b1) + (b2) = | | | | | | | | | | |
| 100% by weight: | | | | | | | | | | |
| (b1) [% by weight] | — | 26.8 | 85.8 | 53.6 | 64.3 | 75.1 | 75.1 | 75.1 | 70.0 | 75.0 |
| (b2) Polyol | 100 | 73.2 | 14.2 | 46.4 | 35.7 | 24.9 | 24.9 | 24.9 | 30.0 | 25.0 |
| mixture (b) in % | | | | | | | | | | |
| by weight based | | | | | | | | | | |
| on (b1) + (b2) = | | | | | | | | | | |
| 100% by weight: | | | | | | | | | | |
| Further parts | 6.8 | 6.8 | 6.8 | 6.8 | 6.8 | 6.8 | 6.8 | 6.8 | 0 | 0 |
| by weight of | | | | | | | | | | |
| filler SAN (b3) | | | | | | | | | | |

*“Water total” means the sum of added water and the water present in other components.

Foam C5 had many cracks and could not be characterized, foam C6 showed pronounced settling and likewise could not be characterized.

TABLE 6
Mechanical properties of the semi-rigid foams obtained.

| | C4 | C5 | C6 | 6 | 7 | 8 | 9 | 10 | 11 | 12 |
|---|---|---|---|---|---|---|---|---|---|---|
| Foam density | 16.9 | — | — | 17.6 | 16.0 | 17.2 | 17.7 | 18.2 | 16.6 | 17.0 |
| [kg/m³] | | | | | | | | | | |
| Compression | 33.5 | — | — | 15.2 | 18.0 | 31.4 | 26.8 | 24.8 | 21.4 | 20.0 |
| hardness 40% | | | | | | | | | | |
| [kPa] (in first | | | | | | | | | | |
| compression) | | | | | | | | | | |
| Tensile strength | 82 | — | — | 35 | 35 | 72 | 69 | 55 | 58 | 62 |
| [kPa] | | | | | | | | | | |
| Elongation at | 21 | — | — | 34 | 24 | 18 | 17 | 17 | 26 | 21 |
| break [%] | | | | | | | | | | |
| Resilience [%] | 15 | — | — | 21 | 26 | 25 | 33 | 30 | 29 | 31 |
| Air permeability | 0.011 | — | — | 0.265 | 0.274 | 0.288 | 0.219 | 0.46 | 0.322 | 0.382 |
| [dm³/s] | | | | | | | | | | |
| AFR [Pa · s/m] | 11600 | — | — | 499 | 359 | 449 | 543 | 246 | 397 | 237 |

“—” Not determined

Even with the use of flame retardants, in this case expandable graphite, it was readily apparent that the inventive semi-rigid foams of examples 6 to 10 had considerably better acoustic properties in respect of sound absorption than comparative example C4. Comparative examples C5 and C6 could not be characterized at all, because of cracking or deposits. For instance, the air permeability for the semirigid foams of examples 6 to 10, determined in accordance with DIN EN ISO 7231, was at least 0.02 dm³/s, whereas the semi-rigid foam of comparative example C4 had air permeabilities of considerably less than 0.02 dm³/s. The inventive semi-rigid foams of examples 6 to 10 likewise had considerably better values in respect of air flow resistance, determined in accordance with DIN EN ISO 9053: 6-10 had AFR values of at most 10 000 Pa·s/m, and in fact of less than 1000 Pa·s/m, whereas C4 had an AFR value of well above 10 000 Pa·s/m, and in fact of well above 11 000 Pa·s/m.

TABLE 7
Amounts used and constituents for production of the freely-foamed semi-rigid polyurethane
foams (total weight of the employed components polyisocyanate composition,
polyols/polyol mixture, and additives approx. 1.6 kg). Amounts specified in parts by
weight unless otherwise stated.

| | C7 | C8 | C9 | 13 | 14 | 15 | 16 | 17 |
|---|---|---|---|---|---|---|---|---|
| Polyol A | | | 25 | 50 | 70 | 70 | 70 | 70 |
| Polyol B | 85 | 85 | 60 | 35 | 15 | 15 | 15 | 15 |
| Polyol D | 15 | 15 | 15 | 15 | 15 | 15 | 15 | 15 |
| Polyol E | 5 | 5 | 5 | 5 | 5 | 5 | 5 | 5 |
| Polyisocyanate | 0 | 0 | 0 | 0 | 140.9 | 0 | 0 | 0 |
| composition (a)-1 | | | | | | | | |
| Polyisocyanate | 139.9 | 0 | 140.6 | 141.2 | 0 | 141.8 | 0 | 0 |
| composition (a)-2 | | | | | | | | |
| Polyisocyanate | 0 | 0 | 0 | 0 | 0 | 0 | 141.2 | 0 |
| composition (a)-4 | | | | | | | | |
| Polyisocyanate | 0 | 138.8 | 0 | 0 | 0 | 0 | 0 | 140.6 |
| composition (a)-5 | | | | | | | | |
| Expandable graphite | 20 | 20 | 20 | 20 | 20 | 20 | 20 | 20 |
| Exolit AP 422 | 5 | 5 | 5 | 5 | 5 | 5 | 5 | 5 |
| DC 198 | 1.5 | 1.5 | 1.5 | 1.5 | 1.5 | 1.5 | 1.5 | 1.5 |
| Sorbidex | 0.5 | 0.5 | 0.5 | 0.5 | 0.5 | 0.5 | 0.5 | 0.5 |
| DEOA | 1.8 | 1.8 | 1.8 | 1.8 | 1.8 | 1.8 | 1.8 | 1.8 |
| Jeffcat DPA | 0.6 | 0.6 | 0.6 | 0.6 | 0.6 | 0.6 | 0.6 | 0.6 |
| Kosmos 29 | 0.05 | 0.05 | 0.05 | 0.05 | 0.05 | 0.05 | 0.05 | 0.05 |
| Water total* | 10 | 10 | 10 | 10 | 10 | 10 | 10 | 10 |
| Index | 85 | 85 | 85 | 85 | 85 | 85 | 85 | 85 |
| Polyol mixture (b) in % by | | | | | | | | |
| weight based on (b1) + | | | | | | | | |
| (b2) = 100% by weight: | | | | | | | | |
| (b1) [% by weight] | 0 | 0 | 26.8 | 53.6 | 75.1 | 75.1 | 75.1 | 75.1 |
| (b2) Polyol mixture (b) in % | 100 | 100 | 73.2 | 46.4 | 24.9 | 24.9 | 24.9 | 24.9 |
| by weight based on (b1) + | | | | | | | | |
| (b2) = 100% by weight: | | | | | | | | |
| Further parts by weight of | 6.8 | 6.8 | 6.8 | 6.8 | 6.8 | 6.8 | 6.8 | 6.8 |
| filler SAN (b3) | | | | | | | | |

*“Water total” means the sum of added water and the water present in other components.

Foam C8 had many cracks and could not be characterized.

TABLE 8
Mechanical properties of the semi-rigid foams obtained.

| | C7 | C8 | C9 | 13 | 14 | 15 | 16 | 17 |
|---|---|---|---|---|---|---|---|---|
| Foam density [kg/m³] | 18.3 | — | 17.0 | 16.7 | 18.1 | 18.1 | 18.4 | 18.6 |
| Compression hardness | 31.6 | — | 18.5 | 15.1 | 20.6 | 21.3 | 21.5 | 20.1 |
| 40% [kPa] (in first | | | | | | | | |
| compression) | | | | | | | | |
| Tensile strength [kPa] | 77 | — | 66 | 50 | 64 | 63 | 60 | 70 |
| Elongation at break [%] | 27 | — | 30 | 38 | 25 | 22 | 22 | 24 |
| Resilience [%] | 18 | — | 21 | 26 | 27 | 26 | 26 | 29 |
| Air permeability [dm³/s] | 0.008 | — | 0.009 | 0.046 | 0.207 | 0.139 | 0.334 | 0.668 |
| AFR [Pa · s/m] | 22300 | — | 33100 | 2610 | 579 | 546 | 361 | 200 |

“—” Not determined

By comparison, the inventive semi-rigid foams of examples 13-17 likewise showed considerably better acoustic properties in respect of sound absorption than comparative examples C7 and C9. Comparative example C8 could not be characterized at all, because of cracking. For instance, the air permeability for the semirigid foams of examples 13 to 17, determined in accordance with DIN EN ISO 7231, was at least 0.02 dm³/s, whereas the semi-rigid foam of comparative examples C7 and C9 had air permeabilities of considerably less than 0.02 dm³/s. The inventive semi-rigid foams of examples 13 to 17 likewise had considerably better values in respect of air flow resistance, determined in accordance with DIN EN ISO 9053: 13-17 had AFR values of well below 10 000 Pa·s/m, whereas C7 and C9 had AFR values of well above 10 000 Pa·s/m, and in fact of well above 10 000 Pa·s/m. Within the inventive semi-rigid foams of examples 14-17, it was also evident that the composition of the polyisocyanate mixture had an effect: For instance, whereas example 14, which had been produced with polyisocyanate composition (a)-1 (less than 50% by weight of 4,4′-MDI and more than 10% by weight of 2,4′-MDI, in each case based on 100% by weight of polyisocyanate composition), had a good AFR value, the AFR values of examples 15, 16, and 17, in which the polyisocyanate composition in each case comprised more than 50% by weight of 4,4′-MDI and less than 10% by weight of 2,4′-MDI, in each case based on 100% by weight of the polyisocyanate composition, were by comparison even more considerably improved, and were below 200 Pa s/m, preferably below 100 Pa s/m.

The comparison with comparative example C8, which had a suitable polyisocyanate composition (a)-5, but not in combination with a suitable polyol mixture, showed that the effect of the composition of the polyisocyanate mixture had shown synergy only with the polyol mixture—foam C8 had many cracks and could not be characterized.

### CITED LITERATURE

WO 2019/002013 A1

EP 1 664 147 B1

EP 2 800 770 B2

EP 1 230 297 B1

WO 2009/003964 A1

WO 2009/138379 A1

“Dow Polyurethanes Flexible Foams”, 2nd edition 1997, chapter 2.

DE 4318120 A1

WO 2006/034800 A1

“Kunststoffhandbuch” [Plastics handbook], volume 7, “Polyurethane” [Polyurethanes], Carl Hanser Verlag, 3rd edition, 1993, chapter 3.1

DE 10314762 A1

“Kunststoffhandbuch” [Plastics handbook], volume 7, “Polyurethane” [Polyurethanes], Carl Hanser Verlag, 3rd edition, 1993, chapter 3.4

1.-15. (canceled)

16. A process for producing a polyurethane foam, comprising the reaction of:
(a) an isocyanate composition comprising at least one polyisocyanate based on diphenylmethane diisocyanate;
(b) a polyol mixture comprising
b1) 50% to 85% by weight of at least one polyether polyol having a hydroxyl value in the range from 10 to 60 mg KOH/g, an OH functionality of more than 2, and an ethylene oxide proportion in the range from 50% to 100% by weight based on the alkylene oxide content of the at least one polyether polyol,
b2) 15% to 50% by weight of at least one polyether polyol having a hydroxyl value in the range from 10 to 100 mg KOH/g, an OH functionality of more than 2, an ethylene oxide proportion in the range from 2% to 30% by weight based on the alkylene oxide content of the at least one polyether polyol, and a proportion of primary OH groups of 40 to 100% based on the total number of OH groups in the at least one polyether polyol,
in each case based on the total amount by weight of constituents (b1) and (b2), which adds up to 100% by weight,
and
b3) 0 to 20 further parts by weight of an optionally derivatized filler, based on 100 parts by weight of components (b1) and (b2), optionally present as a constituent of a graft polyol based on one or more of components (b1) and (b2);
(c) a blowing agent composition comprising water;
wherein the reaction employs the blowing agent composition (c) in a weight-based ratio of the weight of blowing agent composition (c) to the total weight of all isocyanate-reactive compounds used in the reaction in the range from 1:14 to 1:6;
wherein a polyurethane foam having a foam density, determined according to DIN EN ISO 845 of October 2009, of not more than 25 kg/m³ and a compression hardness, determined at 40% compression in the first compression in accordance with DIN EN ISO 3386-1 of October 2015, in the range from 10 to 80 kPa is obtained.

17. The process according to claim 16, wherein the polyol mixture (b) comprises the at least one polyether polyol (b1) in the range from 60% to 82% by weight, based on the total amount by weight of constituents (b1) and (b2), which adds up to 100% by weight; and/or wherein the polyol mixture (b) comprises the at least one polyether polyol (b2) in the range from 18% to 40% by weight, based on the total amount by weight of constituents (b1) and (b2), which adds up to 100% by weight.

18. The process according to claim 16, wherein the optionally derivatized filler according to (b3) is present as a constituent of a graft polyol based on a polyether polyol (b2), in an amount in the range from 0.01 to 20 further parts by weight, based on 100 parts by weight of components (b1) and (b2), and/or the filler according to (b3) is present as a dispersion in a polyether polyol (b2), in an amount in the range from 0.01 to 20 further parts by weight, based on 100 parts by weight of components (b1) and (b2).

19. The process according to claim 16, wherein the polyether polyol (b1) has an OH functionality in the range from 2.2 to 8; and/or wherein the polyether polyol (b1) has a proportion of primary OH groups in the range from 40 to 100%, based on the total number of OH groups in the polyether polyol (b1).

20. The process according to claim 16, wherein the polyether polyol (b2) has a proportion of primary OH groups in the range from 50 to 100%; and/or wherein the polyether polyol (b2) has an OH functionality in the range from 2.2 to 8.

21. The process according to claim 16, wherein the isocyanate composition (a) comprises in the range from 50% to 64% by weight, of 4,4′-diphenylmethane diisocyanate (4,4′-MDI), based on 100% by weight of isocyanate composition (a); and/or wherein the isocyanate composition (a) comprises in the range from 2% to 10% by weight of 2,4′-diphenylmethane diisocyanate (2,4′-MDI) based on 100% by weight of isocyanate composition (a).

22. The process according to claim 16, wherein the polyol mixture (b) further comprises:
b4) at least one further polyether polyol that differs from the at least one polyether polyol according to (b1) and from the at least one polyether polyol according to (b2) and has a hydroxyl value of more than 350 mg KOH/g, in an amount in the range from 0 to 20 further parts by weight, based on 100 parts by weight of components (b1) and (b2).

23. The process according to claim 16, wherein the polyol mixture (b) comprises not more than 5 further parts by weight, based on 100 parts by weight of components (b 1) and (b2), of a further polyether polyol (b5), where (b5) has a hydroxyl value in the range from 10 to 100 mg KOH/g, an OH functionality of at least 2, an ethylene oxide proportion of 0% to 30% by weight based on the content of alkylene oxide, and a proportion of primary OH groups of 0 to 30% based on the total number of OH groups in the polyether polyol (b5).

24. The process according to claim 16, wherein the reaction employs the blowing agent composition (c) in a weight-based ratio to the total weight of all isocyanate-reactive compounds used in the reaction in the range from 1:12 to 1:7.

25. The process according to claim 16, wherein free-rise foaming is carried out.

26. A polyurethane foam obtained by the process according to claim 16.

27. The polyurethane foam according to claim 26, having an air permeability determined in accordance with DIN EN ISO 7231 of December 2010 of at least 0.02 dm³/s;
and/or
an air flow resistance (AFR) determined in accordance with DIN EN ISO 9053-1 of March 2019 of not more than 10 000 Pa·s/m; and/or
a compression hardness, determined at 40% compression in the first compression in accordance with DIN EN ISO 3386-1 of October 2015, in the range from 10 to 80 kPa;
and/or
a foam density, determined according to DIN EN ISO 845 of October 2009, of not more than kg/m³;
and/or
a resilience, determined according to DIN EN ISO 8307 of December 2018, in the range from 15 to 35%.

28. A method comprising utilizing the polyurethane foam according to claim 26 as a sound absorption material.

29. A sound absorption material comprising the polyurethane foam according to claim 26.

30. A method comprising utilizing a polyol mixture (b) comprising:
b1) 50% to 85% by weight of at least one polyether polyol having a hydroxyl value in the range from 10 to 60 mg KOH/g, an OH functionality of more than 2, and an ethylene oxide proportion in the range from 50% to 100% by weight based on the alkylene oxide content of the at least one polyether polyol,
b2) 15% to 50% by weight of at least one polyether polyol having a hydroxyl value in the range from 10 to 100 mg KOH/g, an OH functionality of more than 2, an ethylene oxide proportion in the range from 2% to 30% by weight based on the alkylene oxide content of the at least one polyether polyol, and a proportion of primary OH groups of 40 to 100% based on the total number of OH groups in the at least one polyether polyol,
in each case based on the total amount by weight of constituents (b1) and (b2), which adds up to 100% by weight,
and
b3) 0 to 20 further parts by weight of an optionally derivatized filler, based on 100 parts by weight of components (b1) and (b2), optionally present as a constituent of a graft polyol based on one or more of components (b1) and (b2);
for the production of a polyurethane foam, having at least one of the following properties:
an air permeability determined in accordance with DIN EN ISO 7231 of December 2012 of at least 0.02 dm³/s;
an air flow resistance (AFR) determined in accordance with DIN EN ISO 9053-1 of March 2019 of not more than 10 000 Pa·s/m;
a compression hardness, determined at 40% compression in the first compression in accordance with DIN EN ISO 3386-1 of October 2015, in the range from 10 to 80 kPa;
a foam density, determined according to DIN EN ISO 845 of October 2009, of not more than 25 kg/m³;
a resilience, determined according to DIN EN ISO 8307 of December 2018, in the range from 15 to 35%.
